(19) United States
(12) Patent Application Publication
(10) Pub. No.: US 2015/0286709 A1
(43) Pub. Date: Oct. 8, 2015

(54) METHOD AND SYSTEM FOR RETRIEVING INFORMATION FROM KNOWLEDGE-BASED ASSISTIVE NETWORK TO ASSIST USERS INTENT

(71) Applicant: Samsung Electronics Co., Ltd., Suwon-si (KR)

(72) Inventors: Sailesh Kumar SATHISH, Bangalore (IN); Satnam SINGH, Bangalore (IN)

(21) Appl. No.: 14/667,008

(22) Filed: Mar. 24, 2015

(30) Foreign Application Priority Data
Apr. 2, 2014 (IN) 1782/CHE/2014

(51) Int. Cl. G06F 17/30; G06N 7/00; G06N 5/04

(52) U.S. Cl. CPC G06F 17/30684; G06F 17/30958; G06F 17/30705; G06F 17/3053; G06N 5/04; G06N 7/005

(57) ABSTRACT

A method and a system for retrieving information in a knowledge-based assistive network including a plurality of information sources are provided. The method includes receiving at least one localized query at each of the plurality of information sources, sending one or more localized queries to one or more information sources sent in response to determining intent associated with a user, determining a semantic similarity between the intent and information of respective knowledge graphs each associated with one of the plurality of information sources. The knowledge graphs each include information corresponding to the associated one of the plurality of information sources having knowledge about at least one subject. Further, the method comprises retrieving information from at least one information source in the knowledge-based assistive network in accordance with the determined semantic similarity.

### CROSS-REFERENCE TO RELATED APPLICATION(S)

This application claims the benefit under 35 U.S.C. §119(a) of an Indian patent application filed on Apr. 2, 2014 in the Indian Patent Office and assigned Serial number 1782/CHE/2014, the entire disclosure of which is hereby incorporated by reference.

### TECHNICAL FIELD

The present disclosure relates to a knowledge network. More particularly, the present disclosure relates to a mechanism for retrieving information for assisting a user using a localized knowledge-based assistive network.

### BACKGROUND

Knowledge of a user is expanding exponentially with the number of interactive portals, communities exchanging information constantly over a network. Due to high-level of information exchange between various users across the network, finding relevant information and retrieving the information effectively from the network becomes a challenging task.

In a method according to the related art, information about an expert's profile is stored on a remote server or a database. Further, as the user provides a query for searching relevant information within the network, the expert's profile that is stored within the network is determined and shared with the user in accordance with the search query. Identifying one or more expert's profile within the network consumes a lot of network bandwidth and reduces search efficiency. Further, the expert's profile uploaded in the remote server or the database can be accessed by any user or by a service unknown to the profiled user, which can hamper the privacy and security aspects for the expert profile.

In another method according to the related art, an information source in the form of a knowledge-graph is stored in a remote database and the stored information source can be retrieved by the user by providing a query on a user device. Further, the stored information source is connected with one or more clients based on the query provided by the user. Identifying the information source based on the query within the network can increase the network bandwidth usage. Further, the information source stored in the remote database remains static until the user manually updates the information source. Furthermore, the knowledge-graph information is not personal information of the user but rather information about world entities in general. Also, the information identified may not be locally relevant to user query or do not take current user context (location) and user knowledge into account.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and system for retrieving information in a knowledge-based assistive network from a plurality of information sources based on intent of a user.

Another aspect of the present disclosure is to provide a method and system for receiving one or more information source data by computing a semantic similarity between the intent of the user and a localized query sent to one or more information sources.

Another aspect of the present disclosure is to provide a method and system for displaying one or more information sources to the user based on an expertise-level determined for one or more information sources and allowing the user to communicate with one or more information sources based on the intent of the user.

In accordance with an aspect of the present disclosure, a method for retrieving information in a knowledge-based assistive network including a plurality of information sources is provided. The method includes receiving at least one localized query at each of the plurality of information sources, wherein the at least one localized query is sent in response to determining an intent associated with a user-determining a semantic similarity between the intent and information of respective knowledge graphs each associated with one of the plurality of information sources, wherein the knowledge graphs each comprise information corresponding to the associated one of the plurality of information sources having knowledge about at least one subject, and retrieving information from at least one information source in the knowledge-based assistive network in accordance with the determined semantic similarity.

In accordance with another aspect of the present disclosure, a system for retrieving information in a knowledge-based assistive network including a plurality of information sources, and a server, is provided. The system is configured to receive at least one localized query at each of the plurality of information sources from the server, wherein at the at least one localized query is sent in response to determining an intent associated with a user, determine a semantic similarity between the intent and information of respective knowledge graphs each associated with one of the plurality of information sources, wherein the knowledge graphs each comprise information corresponding to the associated one of the plurality of information sources having knowledge about at least one subject, and retrieve information from at least one information source in the knowledge-based assistive network in accordance with the determined semantic similarity.

In accordance with another aspect of the present disclosure, a computer program product comprising computer executable program code recorded on a computer readable non-transitory storage medium is provided. The computer executable program code, when executed, causes the actions including receiving at least one localized query at each of the plurality of information sources, wherein the at least one localized query is sent in response to determining an intent associated with a user, and determining a semantic similarity between the intent and information of respective knowledge graphs each associated with one of the plurality of information sources, the knowledge graphs each comprise information corresponding to the associated one of the plurality of information sources having knowledge about at least one subject, and retrieving information from at least one information source in the knowledge-based assistive network in accordance with the determined semantic similarity.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a high level overview of a system according to various embodiments of the present disclosure;

FIG. 2 illustrates an electronic device comprising various modules to retrieve information in a knowledge-based assistive network according to various embodiments of the present disclosure;

FIG. 3 illustrates a server comprising various modules to identify and retrieve one or more information sources that correlates with a user's intent within the knowledge-based assistive network according to various embodiments of the present disclosure;

FIG. 4 illustrates a generic representation of a knowledge graph stored in the one or more information sources according to various embodiments of the present disclosure;

FIG. 5 shows an example illustration representing a knowledge graph in an information source associated with a user's knowledge in one or more domain according to various embodiments of the present disclosure;

FIGS. 6A and 6B are other example illustrations of determining difference in an information associated with two knowledge graphs stored in two different information sources according to various embodiments of the present disclosure;

FIG. 7 is a flow diagram illustrating a method for retrieving one or more information source data based on the intent of an user's activity according to various embodiments of the present disclosure;

FIG. 8 is a flow diagram illustrating a method for determining an implicit intent of a user based on an activity performed by the user on an information source according to various embodiments of the present disclosure;

FIG. 9 is an example illustration of determining an implicit intent of the user while browsing the information source on the electronic device according to various embodiments of the present disclosure;

FIG. 10 is a flow diagram illustrating a method for determining an intent of a user based on a search query provided by the user on the information source according to various embodiments of the present disclosure;

FIGS. 11A and 11B show example illustrations of determining an intent of the user based on a search query associated with an application according to various embodiments of the present disclosure;

FIG. 12 is a flow diagram illustrating a method for generating one or more localized queries on a server based on one or more user's intent sent from one or more information sources according to various embodiments of the present disclosure;

FIG. 13 is a flow diagram illustrating a method for determining if the computed semantic similarity on an information source is greater than a threshold value and if the information source is willing to assist the user's intent according to various embodiments of the present disclosure;

FIGS. 14A and 14B are example illustrations of displaying one or more information sources having expertise in the user's intent and is willing to assist the user's intent according to various embodiments of the present disclosure;

FIG. 15 is an example illustration to confirm if one or more information sources are willing to assist the user's intent according to various embodiments of the present disclosure;

FIG. 16 is a flow diagram illustrating a method for tracking, ranking, sorting, and displaying the one or more information sources based on a semantic similarity determined between the user's intent and the information source according to various embodiments of the present disclosure;

FIG. 17 is a flow diagram illustrating a method for establishing a communication session between the one or more information sources and the user according to various embodiments of the present disclosure;

FIG. 18 is a flow diagram illustrating a method for determining a user-information source pair and developing an assistive network by integrating the user-information source pair according to various embodiments of the present disclosure;

FIG. 19 is an example illustration of creating a user-information source pair based on the semantic similarity computed for an user's intent and the information source according to various embodiments of the present disclosure;

FIGS. 20A and 20B are flow diagrams illustrating a method for determining the user's intent and displaying the one or more information sources willing to assist the user's intent according to various embodiments of the present disclosure;

FIGS. 21A and 21B are example illustrations of determining the user's intent and displaying the one or more information sources willing to assist the user's intent according to various embodiments of the present disclosure; and

FIG. 22 illustrates a computing environment implementing the method and system for determining the user's intent and displaying one or more information sources willing to assist the user's intent according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Prior to describing the present disclosure in detail, it is useful to provide definitions for key terms and concepts used herein. Unless defined otherwise, all technical and scientific terms used herein have the same meaning as commonly understood by a personal having ordinary skill in the art to which the present disclosure belongs.

Knowledge-based assistive network: Refers to a network that assists a user in retrieving information quickly and easily and enables the user to take decision effectively. The assistive network comprises a plurality of information sources, a knowledge graph included in the information source, a server communicating with one or more information sources within the network. Further, the assistive network enables the user to provide intent and allows a peer-peer knowledge base search across one or more information sources based on the user's intent. The peer-peer knowledge base search is implemented by computing a semantic similarity between the intent of the user and the information available on one or more information sources within the assistive network.

Information source: Refers to information related to a topic of interest or a domain knowledge that can be displayed on the electronic device and the information source is associated with a person, a company, or an entity. For example, the information source can refer to information regarding a company, a community, a department, an organization, a friend, a friends-of-friend, a web-portal or the like.

Information source data: Refers to meta data of the information source such as the location of the information source, expertise level of the information source, details about the users who owns the information source, and willingness of the user to share the information source with other users, mode of communication preferred by the information source for communicating with the user or the like.

User: Refers to a person who provides intent by performing an activity on the information source for retrieving information from one or more information sources in the assistive network. Further, the intent can be specified explicitly by the user by providing a search query.

Knowledge graph: Refers to a knowledge base that may be represented by using a visually appealing graphical presentation. Knowledge Graph organizes information in the form of nodes, topics, sub-topics, keywords in the information source. The nodes in the knowledge graph represent the knowledge domain the user possess that includes, but not limited to individuals, places, organizations, sports teams, works of art, movies and so on.

Domain: Refers to a topic of interest determined based on the user's intent. Further, the domain is represented as a node in the knowledge graph.

Localized query: Refers to a query that is constructed on the server based on the intent of the user activity performed on the information source considering both the spatial correlation and the temporal correlation. Further, the localized query is sent from the server to one or more information sources in an ad-hoc manner to assist the user with the required information.

Intent: Refers to a topic of interest that a user is looking for in the information source by performing an activity on the electronic device. The intent can be specified either implicitly or explicitly by the user in the electronic device by performing one or more activities on an application.

Activity: Refers to a user's activity performed on the information source such as browsing the information source, typing a search query to retrieve information, selecting keywords in the information source or the like.

An extracted item: Refers to an item extracted from the information source that includes but not limited to keywords, topics in the information source. Further, based on extracted items one or more word vectors or tokens are determined.

A word vector: Refers to the magnitude and direction for determining the context of current topic based on keywords identified in the knowledge graph.

A token: Refers to a unique identifier that identifies the keyword in the information source.

Semantic similarity: Refers to analyzing the keywords, topics in the information source for determining semantically meaningful terminology associated with the extracted items in the information source.

User-information source pair: A pair of users who owns information source with a knowledge graph that includes information regarding the same domain.

The various embodiments of the present disclosure achieve a method and system for retrieving information in a knowledge-based assistive network from a plurality of information sources. The method includes retrieving information based on one or more localized queries received at one or more information sources from the server. Further, the method includes determining the one or more localized queries based on intent associated with a user's activity. The method includes computing a semantic similarity between the localized query sent to the information source and the information stored in the knowledge graph of the information source. Further, the method includes retrieving one or more information source data in the knowledge-based assistive network in accordance to the semantic similarity determined between the intent and one or more information sources. Further, the one or more information source data is displayed to the user for establishing a communication session between the user and the associated information sources.

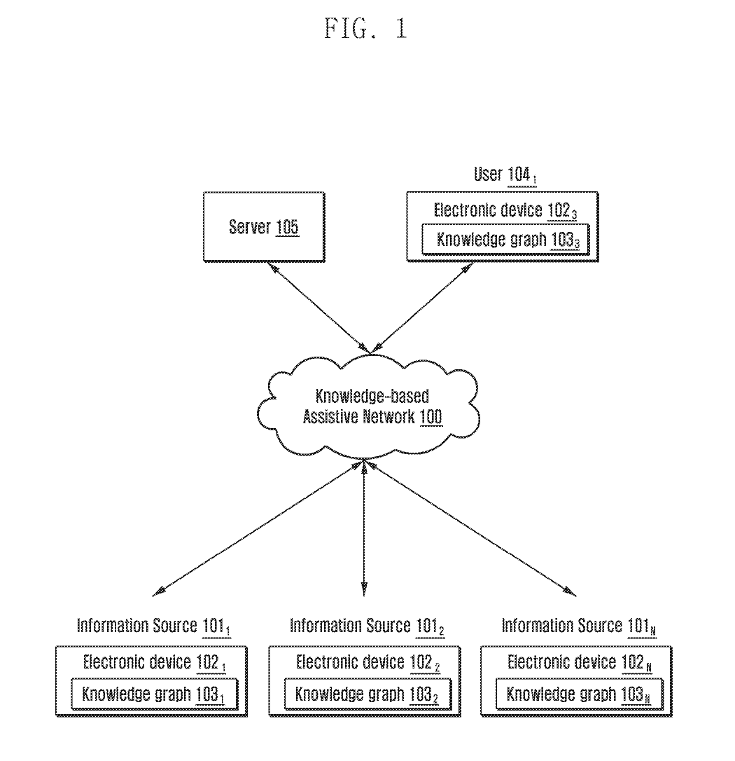

FIG. 1 illustrates a high level overview of a system according to various embodiments of the present disclosure.

Referring to FIG. 1, a knowledge-based assistive network 100 comprises the following the components, namely a network 100, one or more information sources 101_{1-N} (hereinafter the information source is referred to as information source(s) 101), an electronic device 102_{1-N} (hereinafter the electronic device is referred to as the electronic device 102) associated with the information source 101, a knowledge graph 103_{1-N} (hereinafter the knowledge graph is referred to as the knowledge graph 103) stored in the electronic device 102, a user 104₁ (hereinafter the user is referred to as user 104), and a server 105.

The assistive network 100 is configured to provide an environment for communicating with various components (depicted in FIG. 1) to provide assistance to the intent of the user 104.

The information sources 101 is configured to provide information for assisting the user's intent and the information is stored in the electronic device 102 in the form of knowledge graph 103.

The electronic device component 102 is configured to store the information in the form of knowledge graph 103 and allows the user 104 to perform the user activity to capture the intent of the user 104.

The knowledge graph component 103_{1-N} is configured to represent the information associated with the information source 101 in the form of a graph that comprises nodes, topics, sub-topics and keywords.

The user 104 represents a person who is interested in getting assistance for a specific topic from one or more information sources 101 supported in the assistive network 100.

In an embodiment of the present disclosure, the electronic device 102 receives intent from the user 104. In an embodiment of the present disclosure, the user 104 can provide the intent either implicitly or explicitly. In an embodiment of the present disclosure, an implicit intent can be provided by the user 104 by performing an activity on an application running on an electronic device 102. In an embodiment of the present disclosure, an explicit intent can be provided by the user 104 by specifying a localized query on an application running on the electronic device 102.

In an embodiment of the present disclosure, the implicit intent of the user is semantically analyzed on a server 105 for building the localized query based on which one or more information sources are retrieved. Further, the server 105 sends the localized query to one or more information sources 101 for computing semantic similarity between the localized query and the knowledge graph stored in the one or more information sources 101. Further, the computed semantic similarity on the one or more information sources is matched with a threshold value. Further, an information source data of the one or more information sources are sent to the server 105 if the semantic similarity computed on the one or more information sources are greater than the threshold value. Further, the server 105 displays the one or more information source data to the user 104 and the user 104 can establish a communication session (real-time or non real-time) with one or more information sources 101.

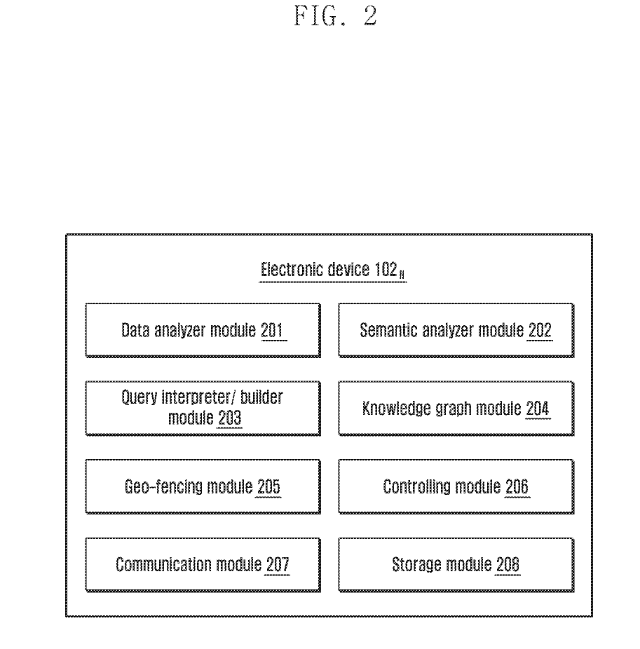

FIG. 2 illustrates an electronic device comprising various modules to retrieve information in a knowledge-based assistive network according to various embodiments of the present disclosure.

Referring to FIG. 2, the electronic device 102_{N} (hereinafter referred to as electronic device 102) comprises the following modules used to retrieve information in a knowledge-based assistive network 100, namely a data analyzer module 201, a semantic analyzer module 202, a query interpreter/builder module 203, a knowledge graph module 204, a geo-fencing module 205, a controlling module 206, a communication module 207, and a storage module 208. The data analyzer module 201 is configured to extract keywords and analyze the data displayed on the electronic device 102. The semantic analyzer module 202 is configured to analyze the keywords and topic of interest for semantic correctness and create word vectors and tokens from the extracted keywords based on the topic of interest.

In an embodiment of the present disclosure, the semantic analyzer module 202 uses Latent Dirichlet Allocation (LDA) algorithm to extract topic word vectors present in a document. A modified version is used where extracted words are combined from web content (after cleaning, morphology) with some existing or pre-loaded web content so as to get fine grained list of topic models (for LDA refinement) present within a web page. Further, a list of the word vectors depicting each topic present within the web page is displayed. Further, an indexing module which uses keywords (sets of keywords) present within each word vector is used to identify occurrence of each topic in the web page. This would form an index denoting a set of word vectors with corresponding location identifiers within the web page. The index gives information about the specific topic that the user browses at a particular location of the web page.

The query interpreter/builder module 203 is configured to interpret the extracted items and build the localized query based on the extracted items. Further, based on the extracted items and the intent of the user 104, the knowledge graph module 204 is configured to depict information in the form of a knowledge graph in the one or more information sources 101.

The geo-fencing module 205 is configured to determine vicinity of the one or more information sources 101 that provides information correlating with the intent of the user 104.

The controlling module 206 can be configured to control the activities performed by the modules supported in the electronic device 102. In an embodiment of the present disclosure, the controlling module 206 can be configured to sending the extracted items or keywords to the server 105 for interpreting a query or building a localized query on the server 105. Further, the controlling module 206 can be configured to compute the semantic similarity between the localized query and the knowledge graph stored on one or more information sources 101. In an embodiment of the present disclosure, the controlling module 206 can be configured to determining matching criteria by comparing the threshold value with the computed semantic similarity received from one or more information sources 101. In an embodiment of the present disclosure, the controlling module 206 can be configured to send one or more information source data to the server 105 based on the determined matching criteria. Further, the controlling module can be configured to monitor user activities on the electronic device 102 and detecting for any change in the user's intent.

The communication module 207 is configured to establish communication session between various components supported in the electronic device 102_{N}. The storage module 208 is configured to store the knowledge graph in the one or more information sources 101.

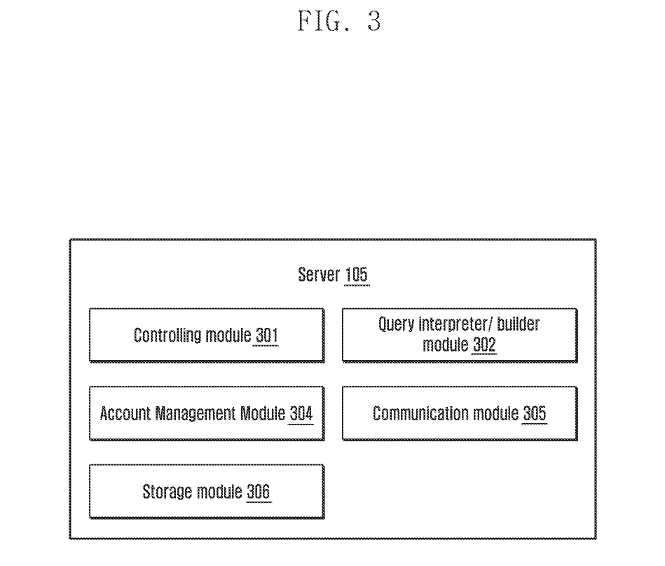

FIG. 3 illustrates a server comprising various modules to identify and retrieve one or more information sources that correlates with a user's intent within the knowledge-based assistive network according to various embodiments of the present disclosure.

Referring to FIG. 3, the server 105 comprises the following modules to identify and retrieve the one or more information sources 101_{1-N} that correlates with the user's intent, namely a controlling module 301, a query interpreter/builder module 302, a geo-fencing module 303, an account management module 304, a communication module 305, and a storage module 306. The controlling module 301 is configured to control the activities performed by the modules supported in the system. The query interpreter/builder module 302 is configured to receive intent from the user 104. Further, the query interpreter/builder module 302 is configured to generate the localized query by extensively interpreting the keywords associated with the topic of interest.

In an embodiment of the present disclosure, the controlling module 301 can be can be configured to perform the following activities on the server 105, namely interpreting or building the localized query based on the extracted items or keywords sent by one or more information sources 101, And displaying one or more information source data to the user based on the willingness of the information source to assist the user 104.

Upon generating the localized query, the geo-fencing module 303 is configured to determine the vicinity of the one or more information sources 101 that provides information correlated with the intent of the user 104. Further, the account management module 304 is configured to manage user details and metadata information of the one or more information sources 101 in the assistive network 100. Based on the above mentioned user details and metadata information, the server 103 retrieves the one or more information sources 101 that have information which correlates with the intent of the user 104 and determines the information source 101 that is in the vicinity of the user 104.

In an embodiment of the present disclosure, the server 105 is configured to send a topic vector set within a query form to the one or more information sources 101. Further, the information sources 101 compares each received localized query within the user's stored knowledge graph (latent topic models and their weights). This comparison is performed through a matching algorithm such as a cosine distance. The matching algorithm returns a normalized metric for each set indicating the expertise level of the information source 101 with each topic. The metric along with an indication of whether the user is willing to help the user 104, along with the mode of available contact is sent back to the server 105.

The communication module 305 is configured to establish communication session between various components supported in the server 105. The storage module 306 is configured to store the user details and the metadata information of the one or more information sources 101 available in the assistive network 100.

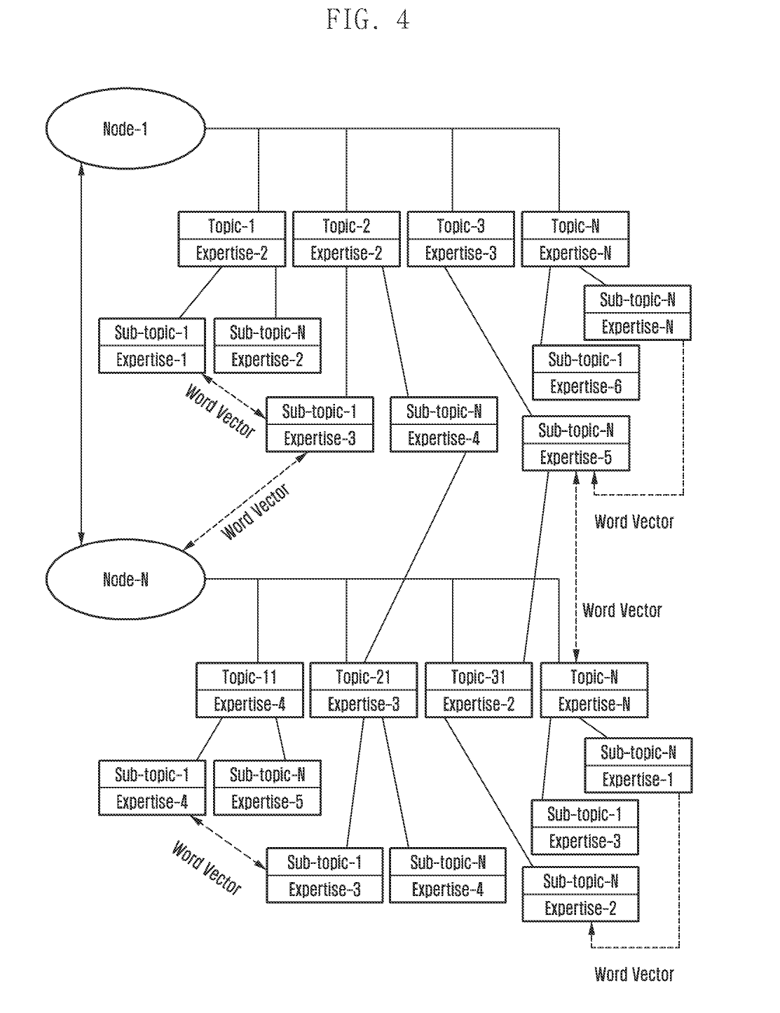

FIG. 4 illustrates a generic representation of a knowledge graph stored in the one or more information sources according to various embodiments of the present disclosure.

Referring to FIG. 4, the knowledge graph has a plurality of nodes from 1-N that depict the topic of interest or domain knowledge. Further, each of the nodes comprises one or more topics and sub-topics with different expertise-level indicated for each topic and sub-topic. Further, the keywords identified within the topic and the sub-topic can be used to determine one or more word vectors for the knowledge graph. For example, Node-1 and Node-N are the nodes identified in the knowledge graph and each of these nodes comprises topics, Topic-1, Topic-2, Topic-3 and so on. Further, each of these topics comprises sub-topics, Sub-topic-1, Sub-topic-2, Sub-topic-3 and so on. Further, each of the topics and sub-topics are indicated with different expertise levels comprising Expertise-1, Expertise-2, Expertise-3, and so on. Further, the dotted line connecting different topics and sub-topics indicate word vectors in the knowledge graph. For example, Node-1 can depict domain knowledge on the topic Politics and Node-N can depict domain knowledge on the topic Science. Further, each of the Nodes (Politics and Science) can comprise the topics office politics, government politics and physics, chemistry respectively. Further, each of the topics can comprise the sub-topic such as metaphysics, nanotechnology, organic chemistry, metallurgy or the like. Further, each of these topics, sub-topics can be associated with an expertise-level.

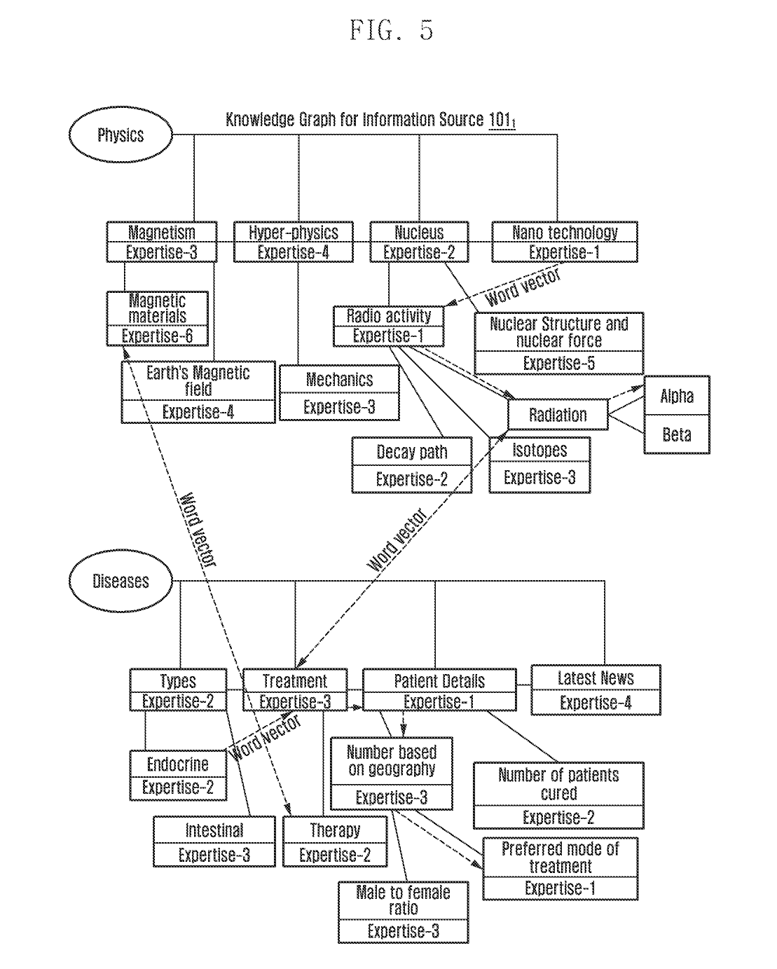

FIG. 5 shows an example illustration representing a knowledge graph in an information source associated with a user's knowledge in one or more domain according to various embodiments of the present disclosure.

Referring to FIG. 5, the information source 101₁ has the knowledge graph having two nodes such as physics and disease. The two nodes indicate that the user has knowledge in physics and disease domains. The physics node comprises topics such as Magnetism, Hyper-physics, Nucleus, and Nanotechnology. Further, each of these topics comprises sub-topics such as Magnetic materials, Earth's magnetic field, Mechanics, Radio-activity, Radiation, Nuclear structure and nuclear force, Decay path, and Isotopes. Further, each of these topics and sub-topics are indicated with different expertise levels. The disease node comprises topics such as types of diseases denoted as Types, Treatment details for the disease denoted as Treatment, Patient details for the type of the disease denoted as Patient details, and latest news about the disease denoted as Latest news. Further, each of these topics are associated with sub-topics such as Endocrine, Intestinal, Therapy, Number based on geography, Male to female ratio, Number of patients cured, Preferred mode of treatment. Further, each of the topics and sub-topics are assigned with different expertise levels. Further, word vectors are created between two sub-topics considered fewer than two different nodes and word vectors are created within the same node for different keywords. For example, one of the word vector shown in the knowledge graph can be interpreted as a therapy treatment for a disease using magnetic materials. Another word vector shown in the knowledge graph can be interpreted as a treatment for a disease based on radiation. The word vector connects topics, sub-topics, keywords within a node or two different nodes and provides contextual information for the user's intent.

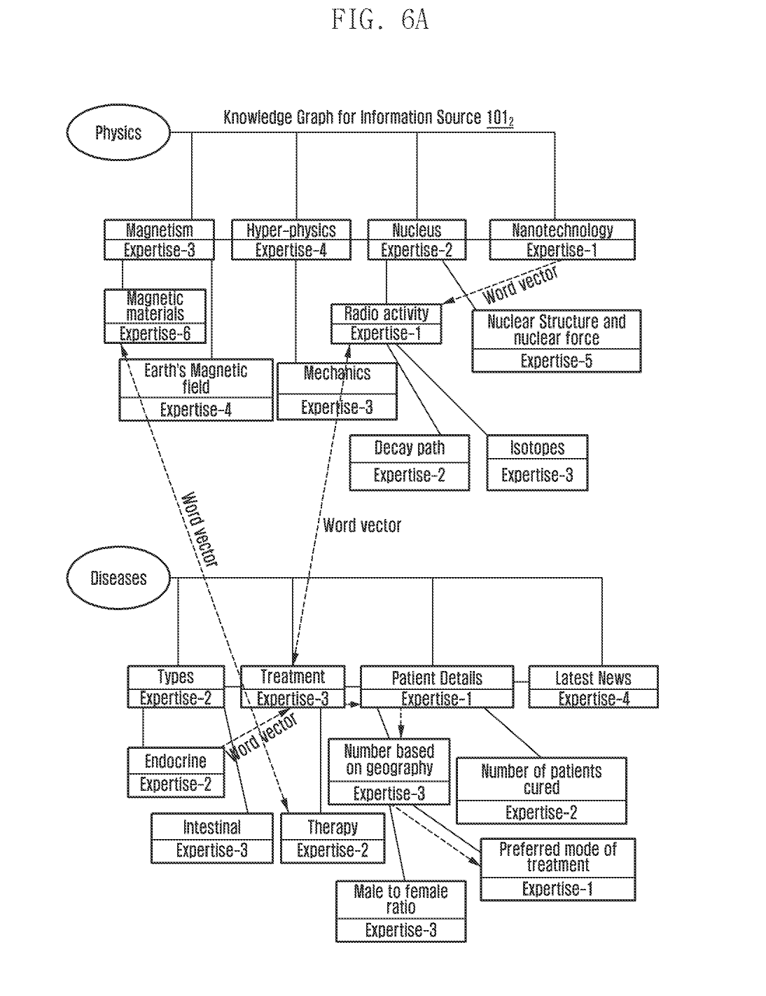

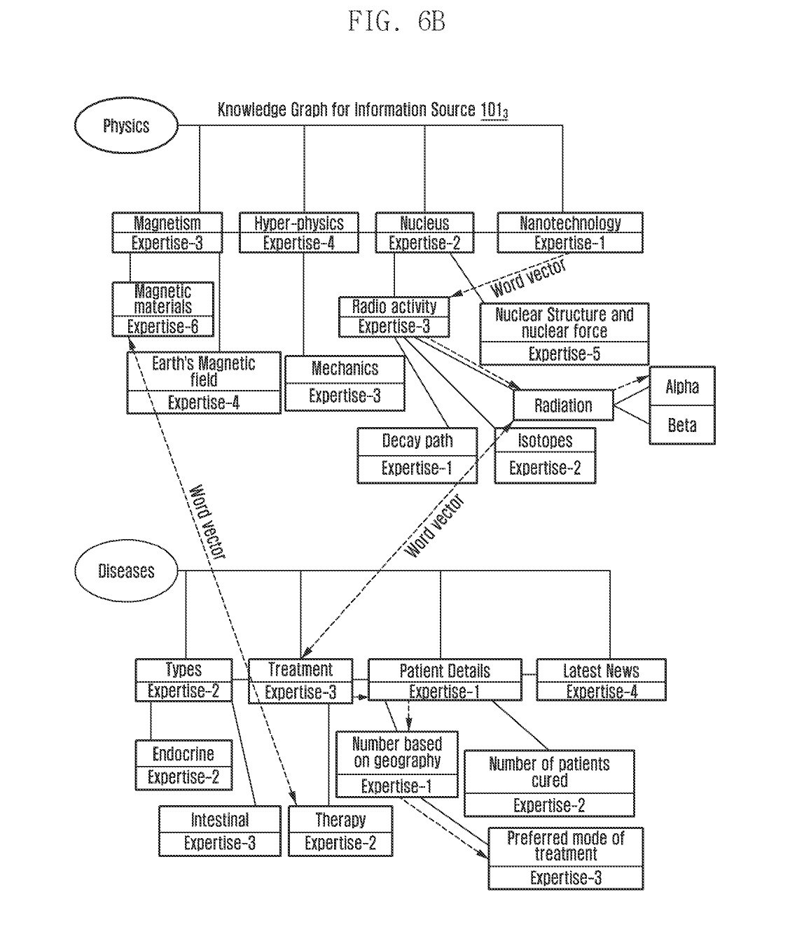

FIGS. 6A and 6B are other example illustrations of determining difference in an information associated with two knowledge graphs stored in two different information sources according to various embodiments of the present disclosure.

FIG. 6A depicts the knowledge graph stored in the information source 101₂. The knowledge graph includes two nodes Physics and diseases depicting a domain knowledge that pertains to the information source 101₂. Further, the knowledge graph indicates that the information source 101₂ has higher expertise level in Radio activity. Further, the knowledge graph includes another node disease which has a sub-topic male to female ratio under the sub-topic number based on geography.

FIG. 6B depicts the knowledge graph stored in the information source 101₃. The knowledge graph includes the nodes physics and diseases depicting the domain knowledge of the information source 101₃. Further, the knowledge graph indicates that the information source 101₃ has less expertise level in the radio activity as compared to the expertise level indicated in information source 101₂ for the same radio activity. Further, the knowledge graph depicted in the information source 101₂ containing disease as a node does not have a sub-topic male to female ratio under the sub-topic number based on geography. Hence, the knowledge graphs stored in the information sources 101₂ and 101₃ depict same domain knowledge. However, the expertise level and the level of information provided at different levels vary in two information sources 101₂ and 101₃ respectively.

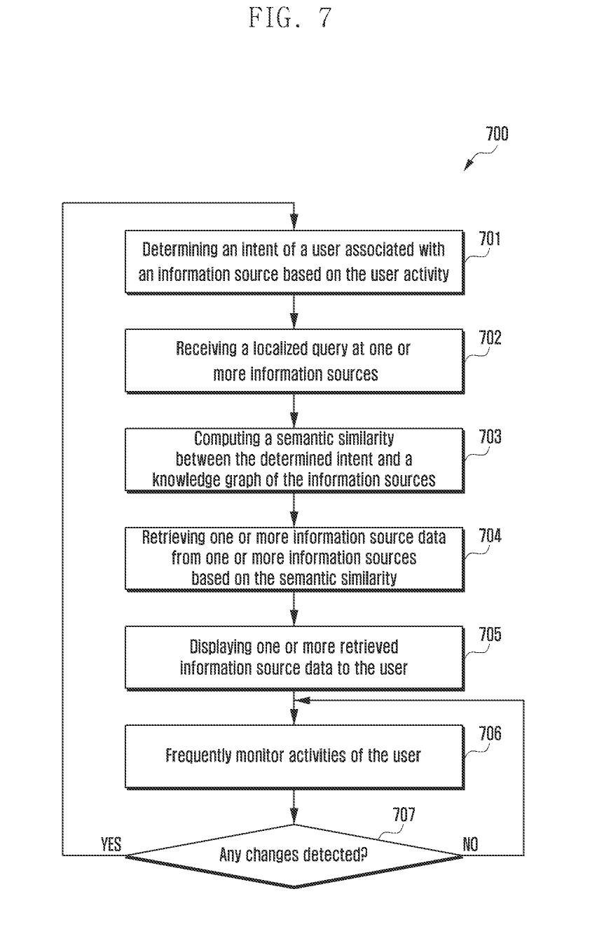

FIG. 7 is a flow diagram illustrating a method 700 for retrieving one or more information source data based on the intent of a user's activity according to various embodiments of the present disclosure. The method 700 depicts the process of retrieving and displaying one or more information source data to the user based on the intent of the user.

In an embodiment of the present disclosure, the intent of the user can be either an implicit intent or an explicit intent, wherein the implicit intent can be determined by selecting the keywords on the information source, identifying semantically associated keywords on the information source or the like. Further, the explicit intent can be determined by specifying a query on an application running in the electronic device 102.

At operation 701, the method 700 includes determining intent of a user associated with an information source based on the user activity. The user performs an activity on an application running on the electronic device 102. In an embodiment of the present disclosure, the controlling module 206 can be configured to determine the user activity performed on the electronic device 102.

For example, the user activity can be a browsing activity, specifying a query, a selection activity, a hovering activity or the like. For example, specifying a query includes providing a query regarding gestational diabetes or any other information required by the user 104.

Based on the user's activity determined by the controlling module 206, the method 700 allows the data analyzer module 201 to extract one or more items from the data and the semantic analyzer module 202 to determine semantically correct keywords from the extracted items. Further, the method 700 allows the controlling module 206 to send the extracted items and keywords to the server 105 for interpreting a query or building a localized query on the server 105. For example, the extracted items from the browser application can be keywords such as songs, actors, director, music composer, producer or the like. Further, based on the extracted keywords, the server 105 can determine the localized query such as “Need information about films”, or “Need information about Bollywood” or the like.

At operation 702, the method 700 includes receiving a localized query at one or more information sources 101. In an embodiment of the present disclosure, the method 700 allows the controlling module 206 to receive the localized query from the server 105 on to one or more information sources 101 within the assistive network 100.

At operation 703, the method 700 includes computing a semantic similarity between the determined intent and a knowledge graph of the information source 101. In an embodiment of the present disclosure, the method 700 allows the controlling module 206 to compute a semantic similarity between the determined intent (captured in the form of the localized query and sent by the server 105) and the knowledge graph stored in one or more information sources 101. For example, the localized query sent from the server 105 “Need information about films” can be used to determine the intent and further the semantic similarity is computed between the determined intent and the information stored in the knowledge graph on one or more information sources 101.

At operation 704, the method 700 includes sending the one or more information source data from the one or more information sources 101 to the server 105. In an embodiment of the present disclosure, the method 700 allows the controlling module 206 to send one or more information source data from one or more information sources 101 to the server 105 based on the semantic similarity determined between the localized query sent by the server 105 and the knowledge graph stored in one or more information sources 101. For example, if information source of user A and information source of user B provides information for the localized query “Need information about films” then information source data of user A and user B are sent to the server 105.

At operation 705, the method 700 includes displaying the one or more information source data to the user 104. In an embodiment of the present disclosure, the method 700 allows the controlling module 301 to display one or more retrieved information source data to the user 104. For example, information source data of user A and user B are displayed to the user 104.

At operation 706, the method 700 includes monitoring and detecting the user activities. In an embodiment of the present disclosure, the method 700 allows the controlling module 206 to monitor the user activities on the electronic device 102 and detect any changes in the user intent. For example, the user 104 can select the topic about pets in the web page.

At operation 707, the method 700 determines a change in the user's intent. In an embodiment of the present disclosure, the controlling module 206 detects any change in the user's intent. The various actions in the method 700 may be performed in the order presented, in a different order or simultaneously. Further, in some embodiments of the present disclosure, some actions listed in FIG. 7 may be omitted.

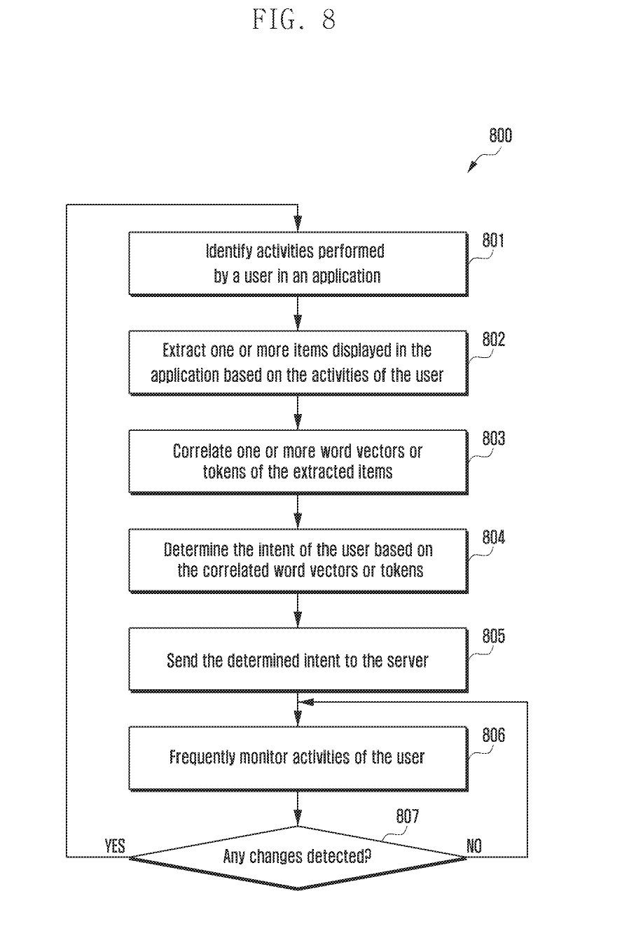

FIG. 8 is a flow diagram illustrating a method 800 for determining an implicit intent of a user based on an activity performed by the user on an information source according to various embodiments of the present disclosure.

FIG. 8 depicts the process of determining implicit intent of the user by extracting one or more items displayed in the application and determining the intent by correlating the word vectors or tokens determined from the extracted items.

At operation 801, the method 800 allows the user 104 to perform an activity on the electronic device 102. In an embodiment of the present disclosure, the controlling module 206 can be configured to determine the user activity performed on the electronic device 102. For example, the user 104 can be blogging actively on the topic about pets. Based on the blogging activity captured by the controlling module 206, the method determines that the intent of the user 104 to know more pets.

At operation 802, the method 800 includes extracting one or more items based on the user's activity performed on the electronic device 102. In an embodiment of the present disclosure, the method 800 allows the data analyzer module 201 to extract one or more items from the application based on the user's activity performed on the electronic device 102. For example, while the user 104 is blogging actively about pets in an on-line journal, the data analyzer module 201 extracts one or more keywords from the on-line journal. The extracted keywords can be such as treating pets at home, vaccination details for pets, food habits of pets, veterinary doctors, and personal hygiene to be taken care and so on.

At operation 803, the method 800 includes correlating one or more word vectors from the extracted items. In an embodiment of the present disclosure, the method 800 allows the semantic analyzer module 202 to correlate one or more word vectors or tokens determined from the extracted items. For example, one of the determined word vectors can be “veterinary doctor for providing vaccination to the pets”.

At operation 804, the method 800 determines the intent of the user 104. In an embodiment of the present disclosure, the method 800 allows the controlling module 206 to determine the intent of the user based on the correlated word vectors or tokens. For example, the word vector “veterinary doctor for providing vaccination to the pets” can determine the intent of the user 104 for which the user 104 requires assistance.

At operation 805, the method 800 sends the determined intent to the server 105. In an embodiment of the present disclosure, the method 800 allows the controlling module 206 to send the determined intent to the server 105. For example, the user's intent to know more about the “veterinary doctor for providing vaccination to the pets” around the vicinity of the user 104 is sent to the server 105.

At operation 806, the method 800 monitors for any additional user activities performed on the electronic device 102. In an embodiment of the present disclosure, the method 800 allows the controlling module 206 to frequently monitor for any additional user activities performed on the electronic device 102. At operation 807, the method 800 determines if any changes are detected. If changes are not detected at operation 807, the method 800 returns to operation 806. If changes are detected at operation 807, the method 800 returns to operation 801. The various actions in the method 800 may be performed in the order presented, in a different order or simultaneously. Further, in some embodiments of the present disclosure, some actions listed in FIG. 8 may be omitted.

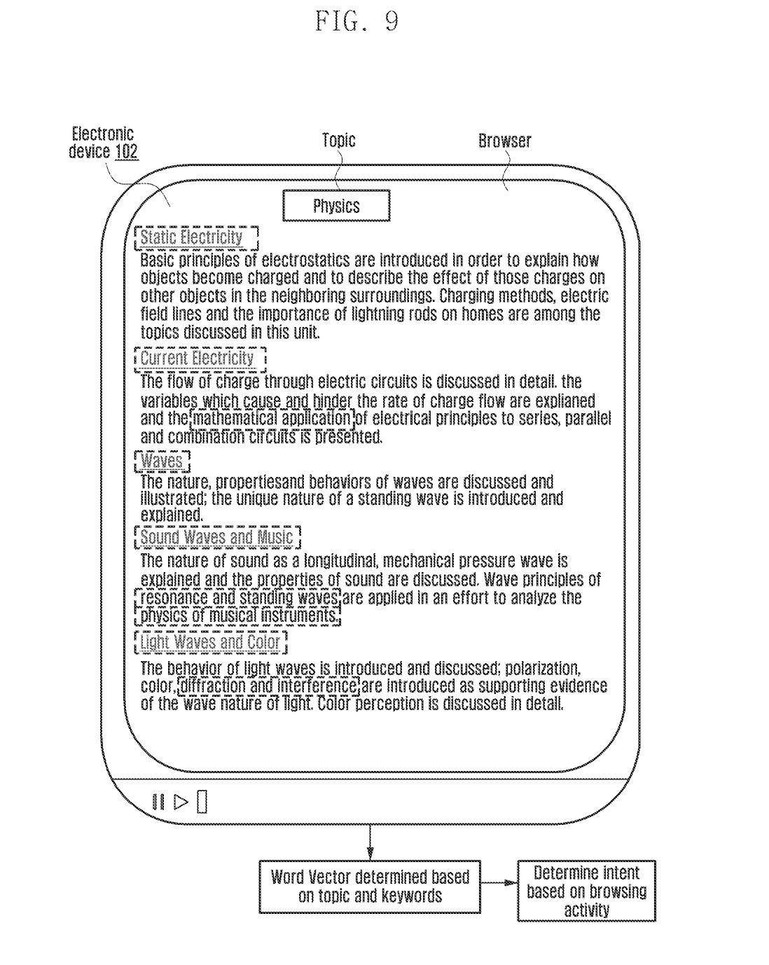

FIG. 9 is an example illustration of determining an implicit intent of the user while browsing the information source on the electronic device according to various embodiments of the present disclosure.

Referring to FIG. 9, the electronic device 102 displays a web page related to the topic on Physics on a browser. Further, the data analyzer module 201 is configured to extract one or more keywords displayed on the browser. For example, the keywords such as static electricity, current electricity, waves, sound waves and music, light waves and color are extracted from the web page. Further, the semantic analyzer module 207 can be configured to determine semantically associated extracted keywords such as resonance and standing waves, physics of musical instruments, diffraction and interferences or the like. Further, the controlling module 206 can be configured to determine the implicit intent of the user is to get information about physics from one or more information sources 101.

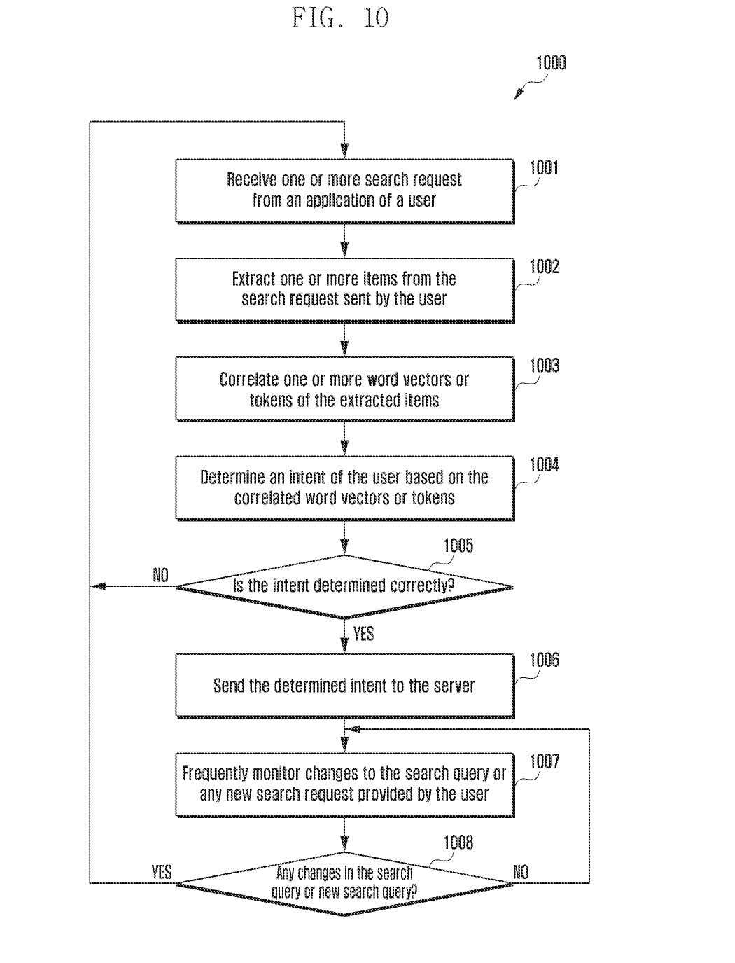

FIG. 10 is a flow diagram illustrating a method 1000 for determining an intent of a user based on a search query provided by the user on the information source according to various embodiments of the present disclosure.

FIG. 10 depicts the process of determining an explicit intent of the user by extracting one or more items provided in the search query and determining the intent by correlating the word vectors or tokens from the extracted items.

At operation 1001, the method 1000 allows the user to provide a search query through an application running on the electronic device 102. In an embodiment of the present disclosure, the controlling module 206 can be configured to allow the user 104 to provide a search query. For example, the user 104 provides a search query “How water is purified using nanotechnology and magnetic materials.”

At operation 1002, the method 1000 includes extracting one or more items from the search query. In an embodiment of the present disclosure, the data analyzer module 201 can be configured to extract one or more items from the search query on the information source 101. For example, the extracted keywords can be water purifier, nanotechnology, and magnetic materials.

At operation 1003, the method 1000 correlates one or more extracted items to determine one or more word vectors or tokens. In an embodiment of the present disclosure, the semantic analyzer module 202 is configured to correlate one or more extracted items to determine one or more word vectors or tokens for the extracted items. For example, the determined word vectors can be “water purification using nanotechnology” and “water purification using magnetic materials.”

At operation 1004, the method 1000 determines the intent of the user based on the word vectors or tokens. In an embodiment of the present disclosure, the controlling module 206 can be configured to determine the intent of the user based on the word vectors or tokens for the extracted items. For example, the controlling module 206 determines the intent of the user 104 that the user 104 is interested to know more about water purification using either magnetic materials or using the nanotechnology.

At operation 1005, the method 1000 includes confirming if the intent of the user 104 is determined correctly. In an embodiment of the present disclosure, the controlling module 206 can be configured to confirm if the intent is determined correctly. If the determined intent is correct, then at operation 1006, the method 1000 includes sending the determined intent to the server 105. In an embodiment of the present disclosure, the controlling module 206 can be configured to send the determined intent to the server 105. If the determined intent is incorrect, then the method 1000 includes refining the search query. In an embodiment of the present disclosure, the controlling module 206 can be configured to allow the user 104 to provide more refined search query. For example, the determined intent of getting more information about water purification using nanotechnology can be further refined as “water purification using nanotechnology and based on X-ray analysis.”

At operation 1007, the method 1000 includes frequently monitoring for any additional queries. In an embodiment of the present disclosure, the controlling module 206 can be configured to frequently monitor for any additional queries or changed queries provided by the user 104.

At operation 1008, if the method 1000 identifies any new query or changed query from the user 104, then the method 1000 allows the controlling module 206 to receive the query for further processing. For example, the user 104 can provide a search query regarding contemporary Bollywood actors.

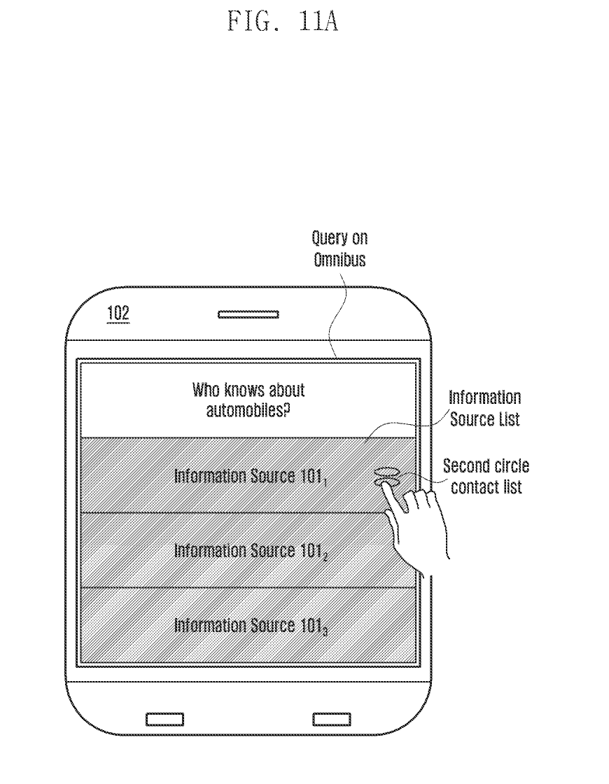

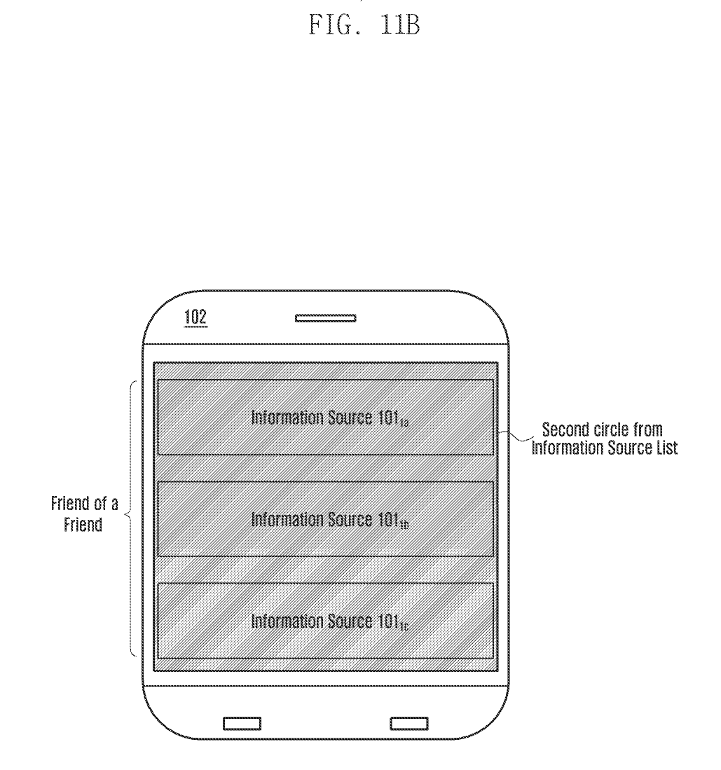

FIGS. 11A and 11B show example illustrations of determining intent of the user based on a search query associated with an application according to various embodiments of the present disclosure.

Referring to FIG. 11A, the electronic device 102 displays a query omnibus on a mobile device 102. Further, the method allows the user to specify a query on the mobile device 102. For example, a query regarding information about automobiles is provided on the mobile device 102. Further, the method allows the query interpreter/builder 203 to interpret the query, and provides a list of information sources 101 based on a semantic similarity computed between the query and the information stored in the knowledge graph of one or more information sources 101. Referring to FIG. 11A, information sources 101₁, 101₂, and 101₃ are the first circle of friends who can provide information for the interpreted query.

In an embodiment of the present disclosure, the first circle of friends list is stored in the information source 101 where the search query is provided.

Further, the information source 101₁ comprises a second circle of contacts that can provide information for the search query. Further, the user can view the second circle of contacts by selecting the ellipses provided beside the information source 101₁.

Referring to FIG. 11B, the mobile device 102 lists the second circle of contacts available in the information source 101₁. For example, the second circle of contacts for the information source 101₁ includes information source 101₁ₐ, information source 101_{1b}, and information source 101_{1c}. Based on the information source list provided on the mobile device 102, the method allows the communication module 207 to establish a connection between the user and the selected information source 101 for sharing the information.

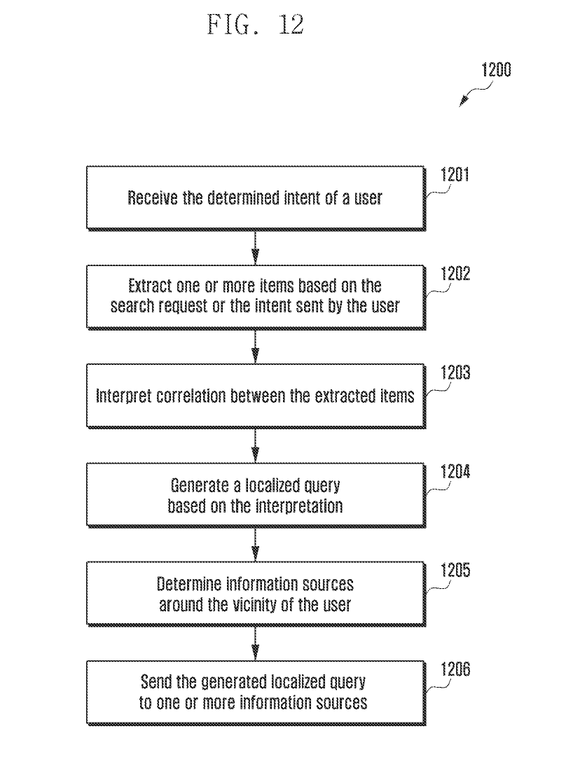

FIG. 12 is a flow diagram illustrating a method 1200 for generating one or more localized queries on a server based on one or more user's intent sent from one or more information sources according to various embodiments of the present disclosure.

FIG. 12 depicts the process of generating a localized query on the server 105 based on the intent sent by the user 104 from the information source 101.

At operation 1201, the method 1200 includes receiving the intent of the user 104. In an embodiment of the present disclosure, the controlling module 206 can be configured to receive the intent of the user 104 on the electronic device 102. For example, after checking the social feeds history such as Twitter, Facebook and so on, the intent of the user 104 can be determined to be “ergonomics in office”.

At operation 1202, the method 1200 includes extracting one or more items from the received intent. In an embodiment of the present disclosure, the data analyzer module 201 can be configured to extract one or more items from the intent received on the information source 101. For example, the extracted keywords from the determined intent can be, injuries at work, office space, employee posture while at work and the like.

At operation 1203, the method 1200 includes correlating extracted items and determining one or more word vectors or tokens from the extracted items. In an embodiment of the present disclosure, the semantic analyzer module 202 can be configured to correlate semantically correct extracted items and determine one or more word vectors or tokens for the extracted items. Further, the method 1200 includes sending the correlated extracted items to the server 105. In an embodiment of the present disclosure, the controlling module 206 can be configured to send the correlated extracted items to the server 105. For example, the determined word vectors can be, kinds of injuries at work, work environment including office space, preventing injuries at work by adopting correct employee posture and the like.

At operation 1204, the method 1200 includes building localized query on the server 105. In an embodiment of the present disclosure, the query interpreter/builder module 302 can be configured to build a localized query on the server 105 based on the correlated extracted items. For example, the localized query built on the server 105 can be “information about office ergonomics”.

At operation 1205, based on the localized query, the method 1200 determines the location of one or more information sources 101. In an embodiment of the present disclosure, the geo-fencing module 303 can be configured to determine the information sources 101 in the vicinity of the user 104 that can provide information for the user's intent. For example, the geo-fencing module 303 determines that information source of user A and information source of user B who are in the close vicinity of the user 104 and who has expert knowledge about office ergonomics.

At operation 1206, the method 1200 includes sending the localized query to one or more information sources 101 determined in the vicinity of the user 104. In an embodiment of the present disclosure, the controlling module 301 can be configured to send the localized query to one or more information sources 101 that is in the vicinity of the user 104 and can assist the user's intent. The various actions in the method 1200 may be performed in the order presented, in a different order or simultaneously. Further, in some embodiments of the present disclosure, some actions listed in FIG. 12 may be omitted.

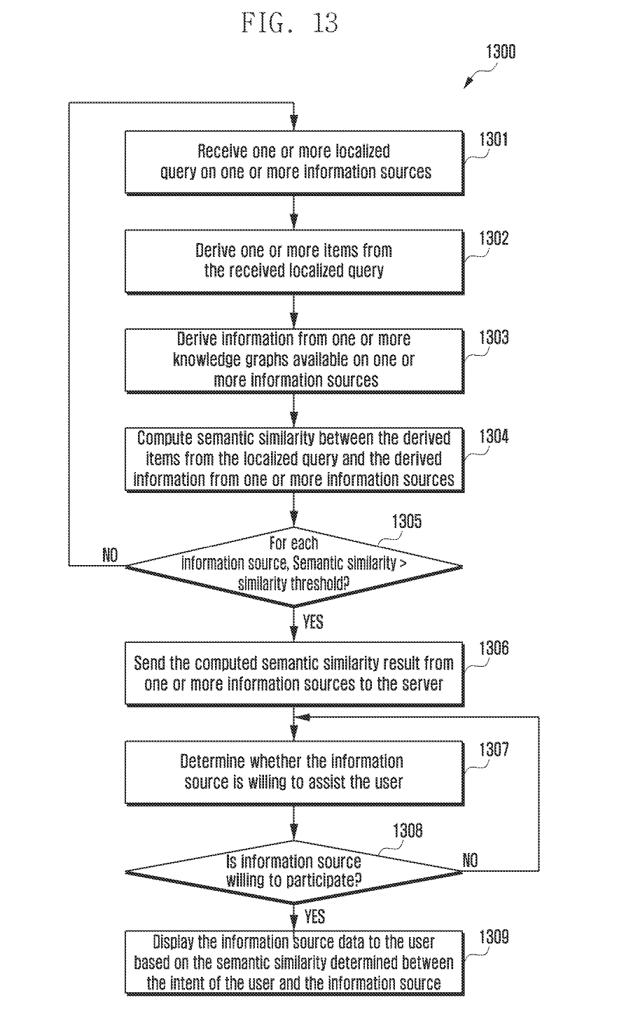

FIG. 13 is a flow diagram illustrating a method 1300 for determining if the computed semantic similarity on an information source is greater than a threshold value and if the information source is willing to assist the user's intent according to various embodiments of the present disclosure.

FIG. 13 depicts the process of determining if the computed semantic similarity in one or more information source 101 is greater than a threshold value and determining if one or more information source 101 is willing to assist the user's intent.

At operation 1301, the method 1300 includes receiving the localized query on one or more information sources 101. In an embodiment of the present disclosure, the controlling module 206 can be configured to receive the localized query from the server 105 on one or more information sources 101. For example, the localized query built on the server 105 can be “information about office ergonomics” and the information source of user A and information source of user B receives the localized query from the server 105.

At operation 1302, the method 1300 includes extracting one or more items from the localized query. In an embodiment of the present disclosure, the data analyzer module 201 can be configured to extract one or more items from the localized query on one or more information sources 101. For example, information source of user A and information source of user B extracts the keywords such as information, office ergonomics, and more such related words.

At operation 1303, the method 1300 includes deriving information from the knowledge graph available on one or more information sources 101. In an embodiment of the present disclosure, the semantic analyzer module 202 can be configured to derive information from the knowledge graph 103 available on one or more information sources 101. For example, the semantic analyzer module 202 derives the information from the knowledge graphs available on information source of user A and information source of user B. Based on the information derivation, the semantic analyzer module 202 determines that the information source of user A includes information about the topics such as, the kind of work the employee does, environment of the office, and the tools used in the office. Further, information source of user B includes information about the following topics, namely avoiding injuries at work place, and promoting ergonomic related culture in the work place.

At operation 1304, the method 1300 includes computing semantic similarity between the derived information the knowledge graph and the extracted items from the localized query. In an embodiment of the present disclosure, the semantic analyzer module 202 can be configured to compute the semantic similarity between the information derived from the knowledge graph 103 and the extracted items from the localized query on one or more information sources 101. For example, the information sources of user A and user B computes the semantic similarity of the localized query “information about office ergonomics” and the derived information from the knowledge graphs on each of these information sources.

At operation 1305, the method 1300 determines if the computed semantic similarity is greater than the threshold value on one or more information sources 101. In an embodiment of the present disclosure, the controlling module 206 can be configured to determine if the computed semantic similarity on one or more information sources 101 is greater than the threshold value. For example, the information sources of user A and user B determine that the computed semantic similarity between the intent and the derived information is greater than the threshold value of 50%.

At operation 1306, the method 1300 includes sending the information source data of one or more information sources 101 to the server 105 if the computed semantic similarity is greater than the threshold value. In an embodiment of the present disclosure, the controlling module 206 can be configured to send the computed semantic similarity from one or more information sources 101 to the server 105 if the computed semantic similarity is greater than the threshold value. For example, information source data of user A and user B are sent to the server 105 as the computed semantic similarity computed between the user intent and the information available in the information source data is greater the threshold value.

At operation 1307, the method 1300 includes determining whether one or more information sources 101 (corresponding to the information source data) are willing to assist the user 104. In an embodiment of the present disclosure, the controlling module 301 can be configured to determine if one or more information sources 101 are willing to assist the user 104. For example, the server 105 sends a confirmation request to the information source of user A and the information source of user B to determine the willingness of user A and user B to assist the user 104.

At operation 1308, the method 1300 includes receiving confirmation from one or more information sources 101 to assist the user 104. In an embodiment of the present disclosure, the controlling module 301 can be configured to receive confirmation from one or more information sources 101 to assist the user 104. For example, information source of user A and information source of user B receives the confirmation request sent by the server 105 to determine the willingness of user A and user B to assist the user 104.

At operation 1309, the method 1300 includes displaying one or more information source data to the user 104 after receiving confirmation from one or more information sources 101 for assisting the user 104. In an embodiment of the present disclosure, the controlling module 301 can be configured to display one or more information source data on the information sources 101 (from which the user intent is sent) if one or more information sources 101 are willing to assist the user 104. For example, information source from user A and information source from user B accepts the request to assist the user 104. Based on the received confirmation, the server 105 displays the information source data to the user 104. The various actions in the method 1300 may be performed in the order presented, in a different order or simultaneously. Further, in some embodiments of the present disclosure, some actions listed in FIG. 13 may be omitted.

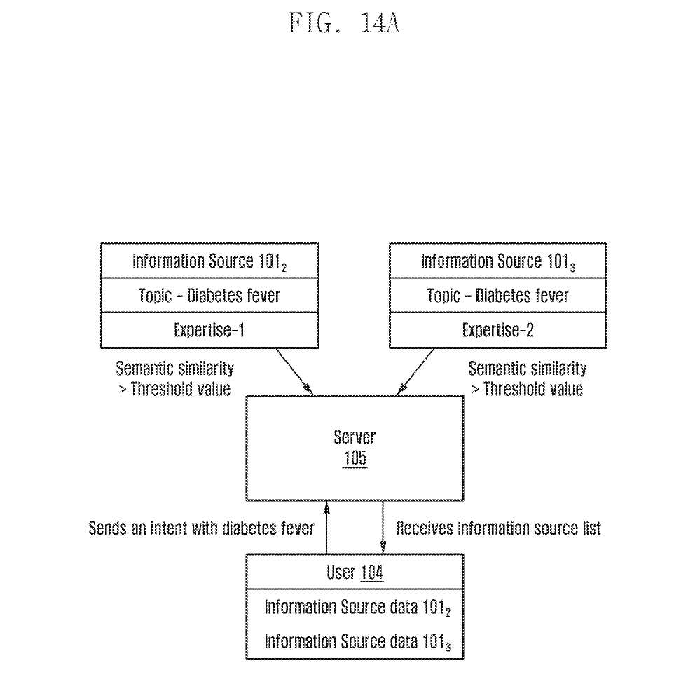

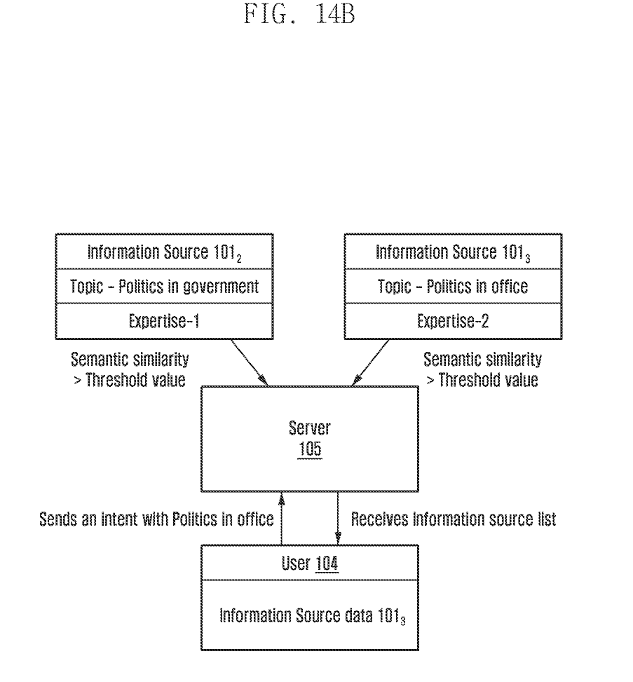

FIGS. 14A and 14B are example illustrations of displaying one or more information sources having expertise in the user's intent and is willing to assist the user's intent according to various embodiments of the present disclosure.

Referring to FIG. 14A, information source 101₂ and information source 101₃ has knowledge on the topic diabetes associated with fever. However, the expertise level associated with the topic of interest in each of the identified information sources differs. For example, information source 101₂ has an expertise level 1 on the topic diabetes associated with fever and information source 101₃ has an expertise level 2 on the topic diabetes associated with fever. Since the user 104 intends to retrieve information about the topic diabetes associated with fever; the server 105 is configured to send a localized query to both the information sources 101₂ and 101₃ respectively. Upon determining the semantic similarity between the information sources 101₂ and 101₃ and the intent of the user 104, the server 105 sends one or more information source data to the user 104 if the computed semantic similarity is greater than a threshold value that is determined by the controlling module 206. In an embodiment of the present disclosure, the threshold value can be set to different values such as 50%, 60%, and 70% in one or more information sources 101. The threshold value can be determined based on the expertise-level expected from the assisting information source 101 related to the intent of the user 104.

For example, if the threshold value is set to 50% and if the computed semantic similarity is greater than 50% on one or more information sources 101, then corresponding information source data is sent to the server 105. Further, the controlling module 301 can be configured to determine if one or more information source data are willing to assist the user 104. Based on the confirmation received, the controlling module 206 displays one or more information source data 101₂ and 101₃ to the user 104.

FIG. 14B depicts that one information source 101₃ has knowledge on the topic politics in office and the other information source 101₂ has knowledge in politics related to government. The user 104 sends intent to know more about the topic politics in office to the server 105. Further, the controlling module 206 can be configured to determine the semantic similarity between the information sources 101₂, 101₃ and the intent of the user 104. Further, the controlling module 206 can be configured to compute the semantic similarity on each of the information sources 101₂ and 101₃ and determine if the computed semantic similarity is greater than the threshold value on each of the information sources 101. Further, the controlling module 206 can be configured to send the information source data of one or more information sources 101 that has the semantic similarity greater than the threshold value. Further, the controlling module 206 can be configured to send the computed semantic similarity to the server 105. Further, the controlling module 301 sends a request to one or more information sources 101 to determine if one or more information sources 101 are willing to assist the user 104. Based on the confirmation received from one or more information sources 101, the user 104 can establish a communication session with the information source 101₃.

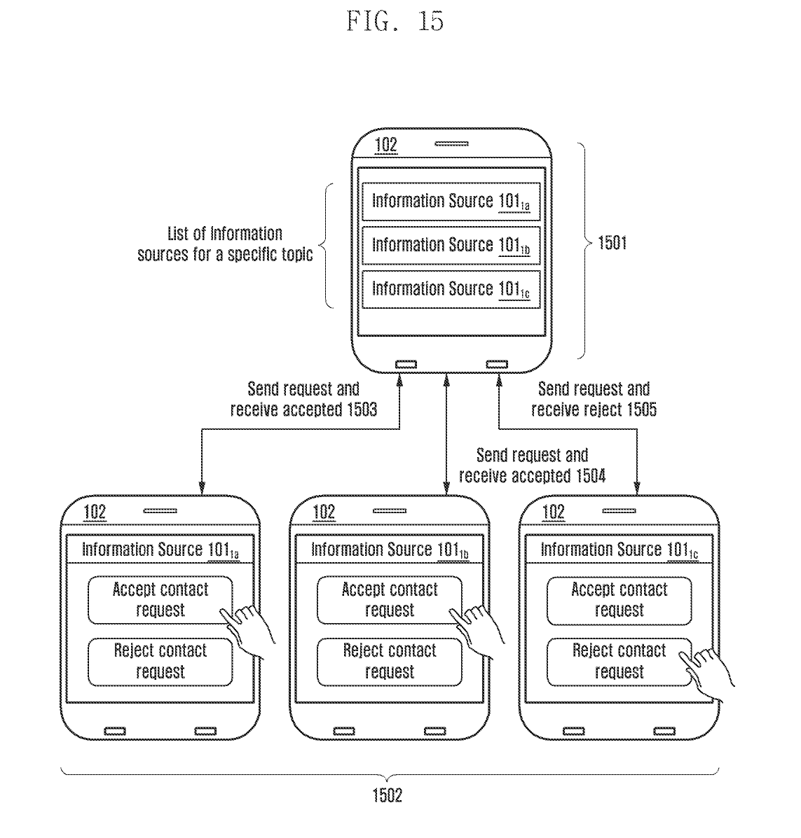

FIG. 15 is an example illustration to confirm if the one or more information sources are willing to assist the user's intent according to various embodiments of the present disclosure.

Referring to FIG. 15, the block 1501 represents a list of information sources 101₁ₐ, 101_{1b}, and 101_{1c} that has information related to a specific topic and is displayed on the electronic device 102. Further, at operations 1503, 1504, and 1505, the electronic device 102 sends a confirmation request to each of the information sources 101₁ₐ, 101_{1b}, and 101_{1c}. Upon receiving the request from one or more information sources 1502, the information sources 101₁ₐ and 101_{1b} accepts the request and the information source 101_{1c} rejects the request. Each of these confirmations is sent to the requesting electronic device 102. For example, if the user is interested in knowing more about automobiles and the method finds few experts in automobiles in the vicinity of the user, the method sends a request to the experts to determine the expert's willingness to assist the user with information regarding automobiles. Upon receiving the request, the experts can send a confirmation to assist the user or reject to assist the user. Based on the confirmation received from the experts, the user can establish a communication session with the experts.

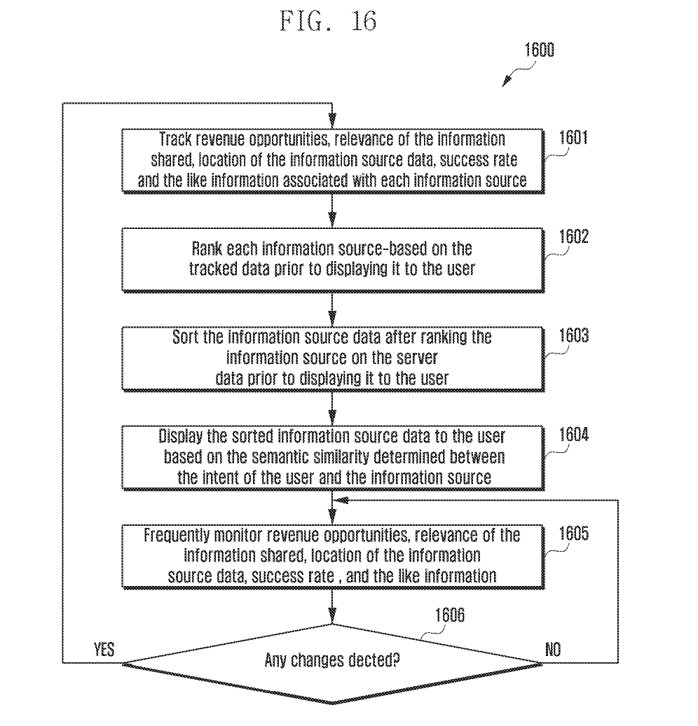

FIG. 16 is a flow diagram illustrating a method 1600 for tracking, ranking, sorting, and displaying the one or more information sources based on a semantic similarity determined between the user's intent and the information source according to various embodiments of the present disclosure.

FIG. 16 depicts the process of tracking the information provided by one or more information sources 101 for the user's intent. Further, based on the tracked data, one or more information sources 101 are ranked and sorted before displaying the information source list to the user 104.

At operation 1601, the method 1600 includes tracking one or more information sources 101 who are willing to assist the user 104. In an embodiment of the present disclosure, the controlling module 301 can be configured to track one or more information sources 101 based on the following factors, namely revenue opportunities provided by the information source for providing relevant information to the intent of the user 104, relevance of the information shared for the user intent, vicinity of the information source with respect to the information source from which the user's intent is sent, success rate of the information shared with one or more information sources 101 or the like. For example, the method tracks information source of user A and information source of user C and identifies that these information sources are close to the vicinity of the requesting user 104. Further, the tracked information sources shows a high-level of expertise related to the topic “symptoms related to diabetes”.

At operation 1602, the method 1600 includes ranking the tracked information sources 101. In an embodiment of the present disclosure, the controlling module 301 can be configured to rank one or more information sources 101 in the assisted network 100 based on the tracked information in the server 105. For example, after tracking information source of user A and information source of user C related to the topics “symptoms related to diabetes”, the information sources can be ranked based on one or more factors listed above.

At operation 1603, the method 1600 includes sorting one or more information sources 101 based on the rank determined for one or more information sources 101. In an embodiment of the present disclosure, the controlling module 301 can be configured to sort one or more information sources 101 in the assisted network 100 based on ranking in the server 105. For example, other information source of user D and information source of user E are ranked lower as compared to the ranking assigned to the information source of user A and the information source of user C due to the vicinity of the information source and the expertise-level demonstrated by the information source in assisting the intent of the user “symptoms related to diabetes”.

At operation 1604, the method 1600 includes displaying the sorted information source data to the user 104. In an embodiment of the present disclosure, the controlling module 301 can be configured to display the sorted information source data to the user 104.

At operation 1605, the method 1600 includes tracking the information shared by one or more information sources 101 to assist the user 104. In an embodiment of the present disclosure, the controlling module 301 can be configured to frequently track one or more information sources based on the information shared with the user 104.

At operation 1606, the method 1600 includes frequently monitoring for any tracking changes detected while tracking one or more information sources 101. In an embodiment of the present disclosure, the controlling module 301 can be configured to determine if changes are detected in accordance to tracking while tracking one or more information sources 101 in the assistive network 100. The various actions in the method 1600 may be performed in the order presented, in a different order or simultaneously. Further, in some embodiments of the present disclosure, some actions listed in FIG. 16 may be omitted.

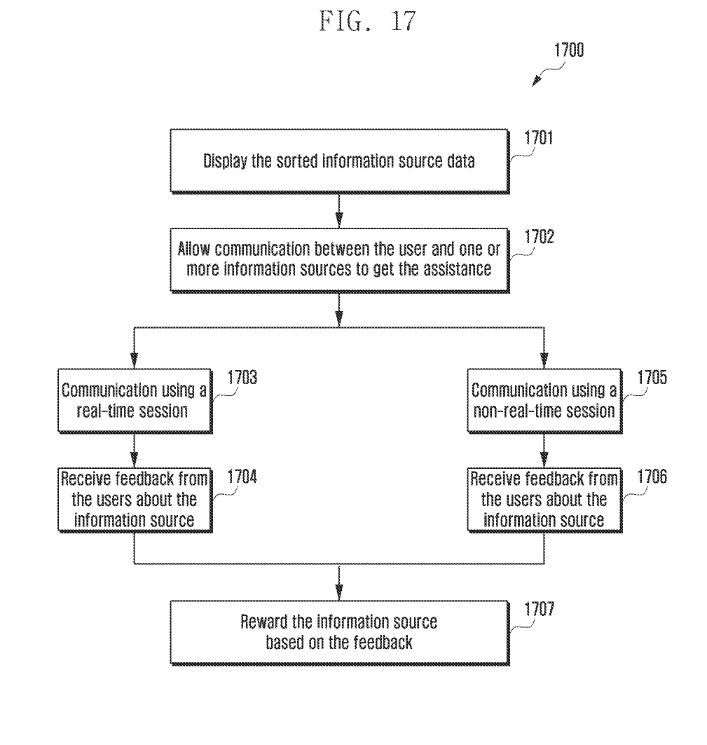

FIG. 17 is a flow diagram illustrating a method 1700 for establishing a communication session between the one or more information sources and the user according to various embodiments of the present disclosure.

FIG. 17 depicts the process of establishing a communication session between the user and one or more information sources 101 to retrieve information based on the user's intent. Further, a feedback is provided to one or more information sources 101 by the user based on the assistance provided to the user. Further, based on the feedback received by one or more information sources 101 a reward is provided to one or more information sources 101.

At operation 1701, the method 1700 includes displaying one or more information source data that are willing to assist the user 104 with the required information. In an embodiment of the present disclosure, the controlling module 301 can be configured to display one or more information source data to the user 104 that are willing to assist the user 104 with information based on the intent of the user 104. For example, the method displays information source of the user D and information source of the user E that are willing to assist the user intent related to the topic “latest news regarding patents”.

At operation 1702, the method 1700 includes establishing the communication session between the user 104 and one or more information sources 101. In an embodiment of the present disclosure, the communication module 207 can be configured to establish the communication session between the user 104 and one or more information sources 101.

At operation 1703, the method 1700 includes establishing a real-time communication session between the user 104 and one or more information sources 101. In an embodiment of the present disclosure, the communication module 207 can be configured to establish a real-time communication session between the user 104 and one or more information sources 101 that can provide assistance to the user's intent. For example, information source of the user D and information source of the user E establishes an on-line chatting session with the user 104 to discuss about the intent of the user 104.

At operation 1705, the method 1700 includes establishing a non-real time communication session between the user 104 and one or more information sources 101. In an embodiment of the present disclosure, the communication module 207 can be configured to establish a non-real time communication session between the user 104 and one or more information sources 101 that can provide assistance to the user's intent. For example, information source of the user D and information source of the user E organizes for a face-to-face meeting session with the user 104 to discuss about the intent of the user 104.

At operations 1704 and 1706, the method 1700 includes receiving feedback from the user 104 about the assistance provided by one or more information sources 101. In an embodiment of the present disclosure, the controlling module 301 can be configured to receive feedback from the user 104 about the assistance provided by one or more information sources 101 to the user 104. Based on the feedback received by the server 105, the method 1700 allows the controlling module 301 to determine and provide a reward for one or more information sources 101 at operation 1707. The various actions in the method 1700 may be performed in the order presented, in a different order or simultaneously. Further, in some embodiments of the present disclosure, some actions listed in FIG. 17 may be omitted.

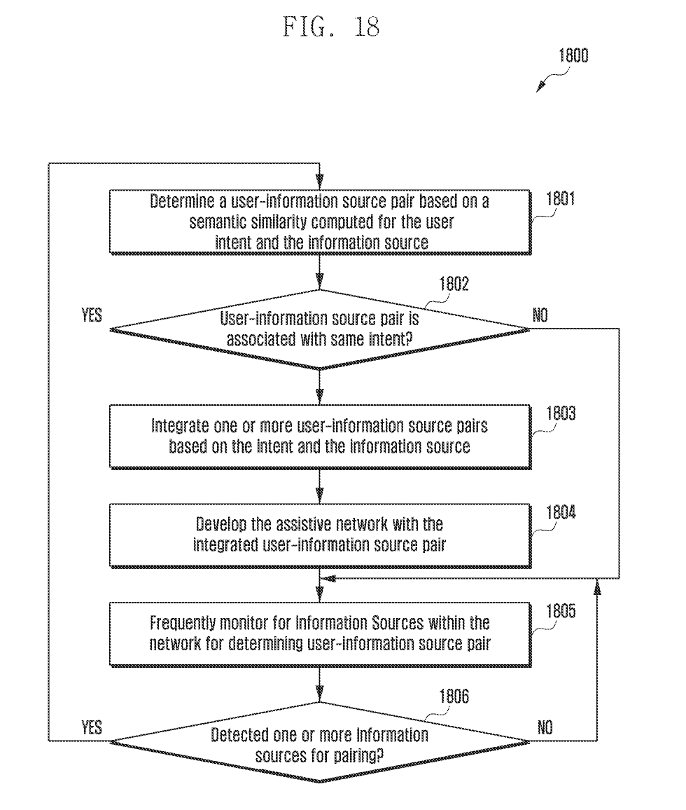

FIG. 18 is a flow diagram illustrating a method 1800 for determining a user-information source pair and developing an assistive network by integrating the user-information source pair according to various embodiments of the present disclosure.

FIG. 18 depicts the process of determining one or more information sources 101 that can assist the user 104 with similar information and further developing the assistive network 100 by integrating one or more users associated with one or more information sources 101 that provide similar information.

At operation 1801, the method 1800 includes determining the information provided by one or more information sources 101 by computing the semantic similarity between the user intent and the information source 101. In an embodiment of the present disclosure, the controlling module 206 can be configured to determine the information provided by one or more information sources 101 by computing semantic similarity between the user intent and the information source 101. For example, information source of the user A and information source of the user B determines the information related to music and art based on the user's intent.

Further, the method 1800 includes determining the user 104 associated with one or more information sources 101 after computing the semantic similarity. In an embodiment of the present disclosure, the controlling module 206 can be configured to determine the user associated with one or more information sources for which the semantic similarity is computed. Further, the method 1800 includes determining a plurality of users associated with one or more information sources 101 who has similar information in the information source 101. In an embodiment of the present disclosure, the method 1800 determines information source of the user C and information source of the user D to have similar information related to music and art. In an embodiment of the present disclosure, the controlling module 206 can be configured to determine one or more users are associated with one or more information sources 101 based on the computed semantic similarity and who has similar information. Further, the method 1800 includes sending user details of one or more information sources 101 who has similar information to the server 105. For example, if the user intent is related to music and art, then information source data of the users A, B, C and D are sent to the server 105. In an embodiment of the present disclosure, the controlling module 206 of one or more information sources 101 can be configured to send one or more user details associated with one or more information sources 101 to the server 105.

At operation 1802, the method 1800 includes determining if the plurality of users is listed in the server 105 based on the information supported in one or more information sources 101. For example, information source data of the users A, B, C and D are listed in the server 105 for the information related to music and art. In an embodiment of the present disclosure, the controlling module 301 can be configured to determine if a plurality of users is listed in the server 105 based on the information supported in one or more information sources 101.

At operation 1803, the method 1800 includes integrating the plurality of users determined on the server 105. In an embodiment of the present disclosure, the controlling module 301 can be configured to integrate the plurality of users associated with one or more information sources 101 determined based on the semantic similarity. For example, information source data of the users A, B, C, and D are integrated with information related to music and art.

At operation 1804, the method 1800 includes developing the user-information source pair in the server 105. In an embodiment of the present disclosure, the controlling module 301 can be configured to develop the user-information source pair. In an embodiment of the present disclosure, pairing of information source data of the users A, B, C, and D with the information related to the information source 101 are termed as user-information source pair.

At operation 1805, the method 1800 includes monitoring for additional user-information source pair available in the network 100. In an embodiment of the present disclosure, the controlling module 301 can be configured to frequently monitor for any additional information source 101 user based on a similar intent identified in the assistive network 100.

At operation 1806, the method 1800 includes detecting one or more information sources 101 associated with one or more users having similar information. In an embodiment of the present disclosure, the controlling module 301 is configured to detect one or more information sources 101 associated with one or more users for pairing. For example, the method may detect another information source of the user X who has information related to music and art. If the controlling module 301 detects an information source 101 in the assistive network 100, then the controlling module 301 computes the semantic similarity between the user intent and the information source 101 for determining a user-information source pair. Otherwise, the method 1800 includes monitoring for the plurality of users associated with one or more information sources 101 having similar information. In an embodiment of the present disclosure, the controlling module 301 is configured to frequently monitor for one or more information sources 101 in the assistive network 100. The various actions in the method 1800 may be performed in the order presented, in a different order or simultaneously. Further, in some embodiments of the present disclosure, some actions listed in FIG. 18 may be omitted.

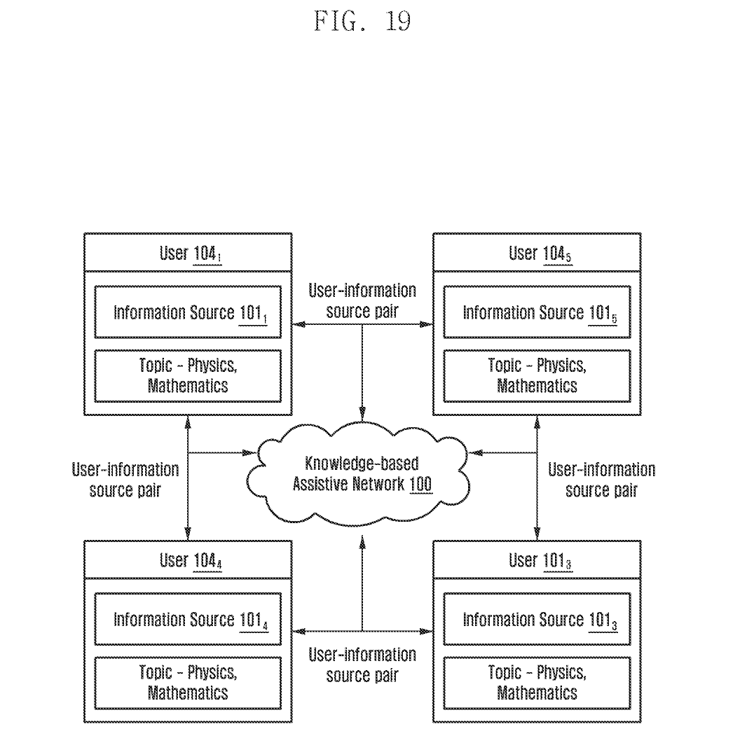

FIG. 19 is an example illustration of creating a user-information source pair based on the semantic similarity computed for a user's intent and the information source according to various embodiments of the present disclosure.

Referring to FIG. 19, information source 101₁ and information source 101₅ can provide same topic of interest or information for assisting one or more users 104 intent. For example, both the information sources 101₁ and 101₅ provides physics and mathematics information for the assisting the user intent. Further, the users associated with these information sources are user 104₁ and user 104₅ respectively. Hence, both information sources 101₁ and 101₅ associated with the users can be paired together to provide a user-information source pair within the assistive network 100. Further, two more information sources 101₄ and 101₃ also provide physics and mathematics information for assisting the user 104. Hence, the users associated with the information sources 101₄ and 101₃ are integrated with the users associated with the information sources 101₁ and 101₅. After integrating the information source users of 101₁, 101₃, 101₄, and 101₅ as user-information source pairs, the user-information source pairs can be used to develop the assistive network 100.

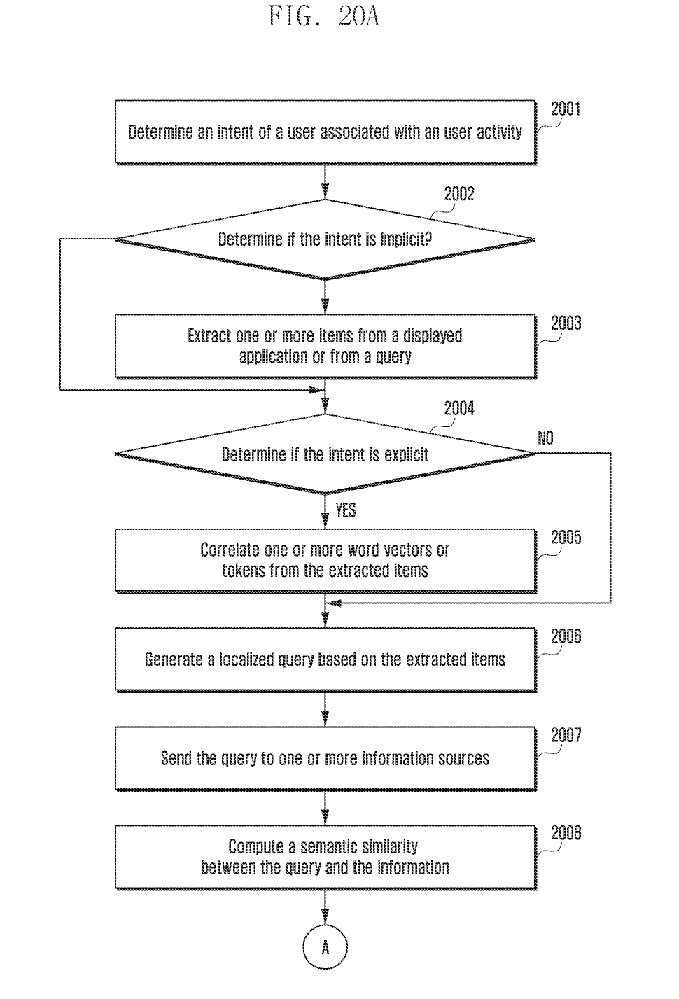

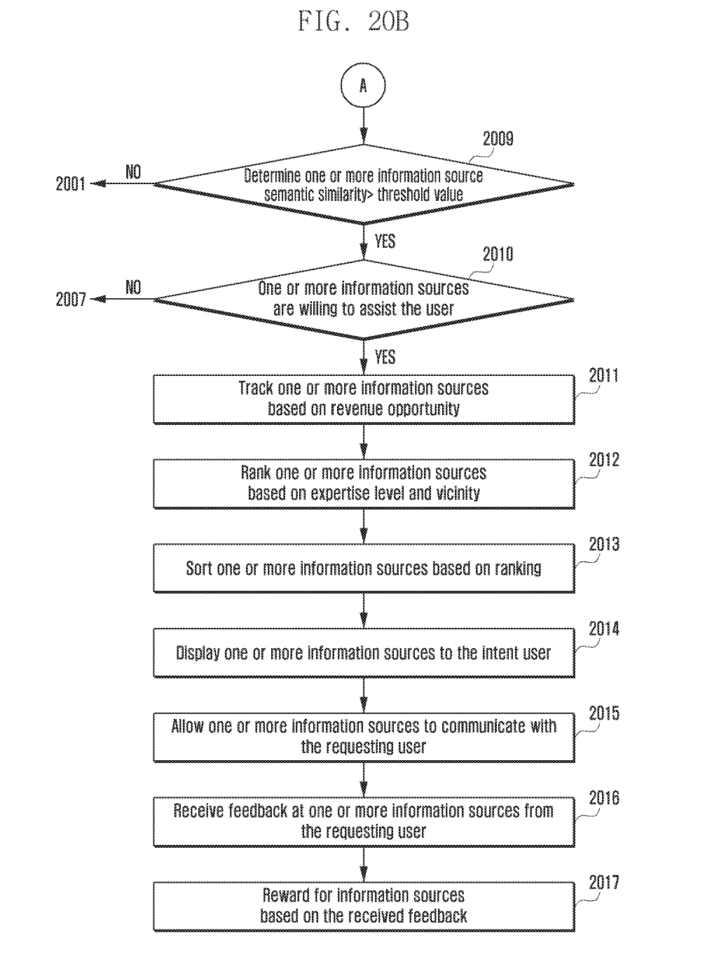

FIGS. 20A and 20B are flow diagrams illustrating a method 2000 for determining the user's intent and displaying the one or more information sources willing to assist the user's intent according to various embodiments of the present disclosure.

FIGS. 20A and 20B depict the process of determining the user's intent received at one or more information sources 101 and displaying one or more information sources 101 willing to assist the user's intent.

At operation 2001, the method 2000 includes receiving the intent of the user 104. In an embodiment of the present disclosure, the controlling module 206 can be configured to receive intent of the user on the electronic device 102.

At operation 2002, the method 2000 includes determining the intent of the user 104. In an embodiment of the present disclosure, the controlling module 206 is configured to determine if the intent is an implicit intent. If the intent is determined to be an implicit intent, at operation 2003, the method 2000 includes extracting one or more items from the implicit intent of the user 104. In an embodiment of the present disclosure, the data analyzer module 201 is configured to extract one or more items from the implicit intent of the user 104.

At operation 2004, the method 2000 includes determining if the intent of the user 104 is explicit. In an embodiment of the present disclosure, the controlling module 206 can be configured to determine if the intent is explicit.

At operation 2005, the method 2000 includes correlating one or more word vectors or tokens by semantically analyzing the extracted keywords. In an embodiment of the present disclosure, the semantic analyzer module 202 can be configured to correlate one or more word vectors or tokens by semantically analyzing the extracted items. Further, the correlated word vectors or tokens are sent to the server 105 for building a localized query.

At operation 2006, the method 2000 includes building the localized query based on the extracted items. In an embodiment of the present disclosure, the query interpreter/builder module 203 can be configured to build the localized query based on the extracted items.

At operation 2007, the method 2000 includes sending the localized query from the server 105 to one or more information sources 101. In an embodiment of the present disclosure, the controlling module 301 can be configured to send the localized query from the server 105 to one or more information sources 101.

At operation 2008, the method 2000 includes determining the semantic similarity between the intent of the user 104 and the information available on one or more information sources 101. In an embodiment of the present disclosure, the semantic analyzer module 202 can be configured to compute a semantic similarity between the intent of the user 104 and the information available in one or more information sources 101.

At operation 2009, the method 2000 includes determining if the computed semantic similarity is greater than the threshold value on one or more information sources 101. In an embodiment of the present disclosure, the controlling module 206 can be configured to determine if the computed semantic similarity is greater than the threshold value on one or more information sources 101. Further, if one or more information sources 101 determine the computed semantic similarity to be greater than the threshold value, then the controlling module 206 sends the information source data of one or more information sources 101 to the server 105. If the computed semantic similarity is not greater than the threshold value, then the method continues to determine for any additional user intent on the information source 101.

At operation 2010, the method 2000 includes determining of one or more information source data sent to the server 105 is willing to assist the user 104. In an embodiment of the present disclosure, the controlling module 301 can be configured to determine if one or more information source data listed in the server 105 are willing to assist the user 104. Further, if the information sources 101 are not willing to assist the user 104, then the controlling module 301 can be configured to send the localized query to other information sources 101 in the assistive network 100.

At operation 2011, the method 2000 includes tracking the one or more information sources 101 based on the assistance provided by the one or more information sources 101. In an embodiment of the present disclosure, the controlling module 301 can be configured to track one or more information sources 101 willing to assist the user 104 based on one or more factors related to the assistance by the information source 101.

At operation 2012, the method 2000 includes ranking the plurality of information sources 101 after tracking the plurality of information sources 101. In an embodiment of the present disclosure, the controlling module 301 can be configured to rank one or more information sources 101 based on the tracked data.

At operation 2013, the method 2000 includes sorting the plurality of information sources 101 based on the ranking. In an embodiment of the present disclosure, the controlling module 301 can be configured to sort the ranked information sources 101 on the server 105.

At operation 2014, the method 2000 includes displaying one or more information source data to the user 104 based on the semantic similarity computed on one or more information sources 101 and the user's intent. In an embodiment of the present disclosure, the controlling module 301 can be configured to display one or more information source data to the user 104 based on the intent of the user 104.

In an embodiment of the present disclosure, the semantic analyzer module 202 computes semantic similarities between the intent of the user 104 and the information associated with one or more information sources 101.

At operation 2015, the method 2000 includes establishing the communication session between the user 104 and one or more information sources 101 who are willing to assist the user 104. In an embodiment of the present disclosure, the communication module 305 can be configured to establish the communication session between the user 104 and one or more information sources 101 who are willing to assist the user 104.

In an embodiment of the present disclosure, the communication sessions can be established through a real-time session or a non-real time session. Example for a real-time session includes but not limited to on-line chat, interaction through social networking sites, interaction through web sites or the like. Example for a non-real time session includes but not limited to communication through e-mails, telephonic conversation, meeting face-to-face or the like.

At operation 2016, the method 2000 includes receiving feedback from the user 104 based on the assistance provided by one or more information sources 101. In an embodiment of the present disclosure, the controlling module 206 can be configured to receive feedback from the user 104 for one or more information sources 101 based on the assistance provided to the user 104.

At operation 2017, the method 2000 includes rewarding one or more information sources 101 based on the feedback received from the user 104 for one or more information sources 101. In an embodiment of the present disclosure, the controlling module 301 can be configured to reward one or more information sources 101 based on the feedback received from the user 104.

In an embodiment of the present disclosure, rewarding one or more information sources 101 comprises providing incentives to the assisting information source, increasing the ranking order of the information source, assigning reward points to the information source or the like. The various actions in the method 2000 may be performed in the order presented, in a different order or simultaneously. Further, in some embodiments of the present disclosure, some actions listed in FIGS. 20A and 20B may be omitted.

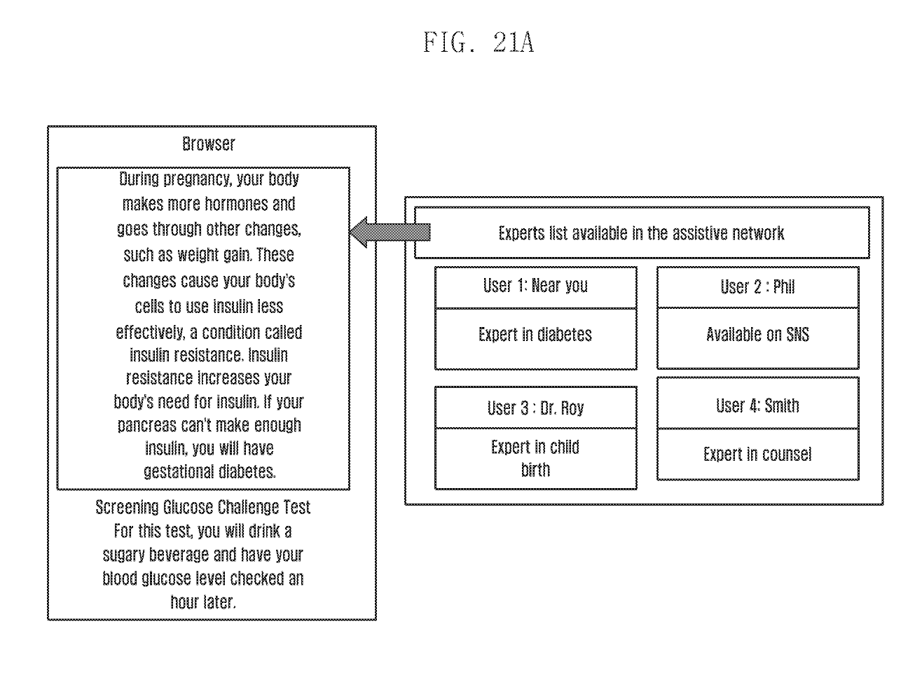

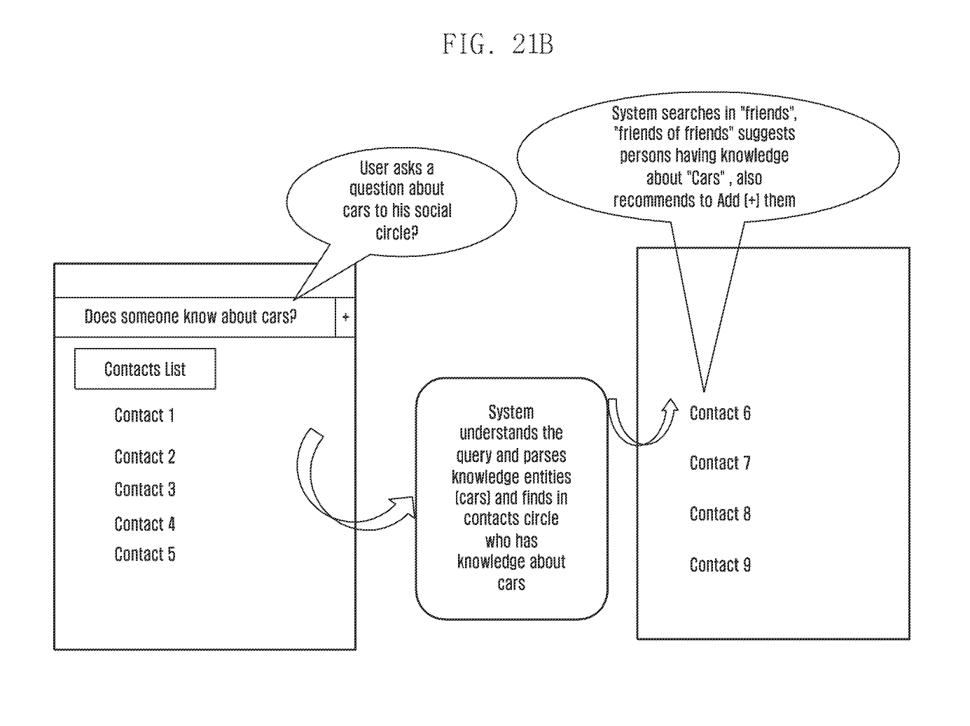

FIGS. 21A and 21B are example illustrations of determining the user's intent and displaying the one or more information sources willing to assist the user intent according to various embodiments of the present disclosure.

Referring to FIG. 21A, the user 104 is browsing a website that has information about gestational diabetes. Further, as the user 104 browses more on topics related to gestational diabetes, the proposed method determines the intent of the user 104 i.e., “gestational diabetes”. After identifying the intent of the user, the proposed method displays one or more experts identified within the assistive network 100 and within the vicinity of the user 104. Further, the method allows the user 104 to communicate with one or more experts displayed in the browser based on the expert's availability. Further, FIG. 21B depicts that the proposed method allows the user to provide a search query in an omnibus bar associated with an application running in an electronic device 102. In the current example, the user 104 is providing a query for retrieving information related to cars in the first circle of contacts of the user 104 stored in the electronic device 102. Based on the query, the electronic device 102 displays the first circle of contacts stored in the electronic device 102 and allows the user 104 to select the second circle of contacts from the first circle of contacts. Further, the user can select one or more contacts displayed on the electronic device 102 to retrieve more information about cars.

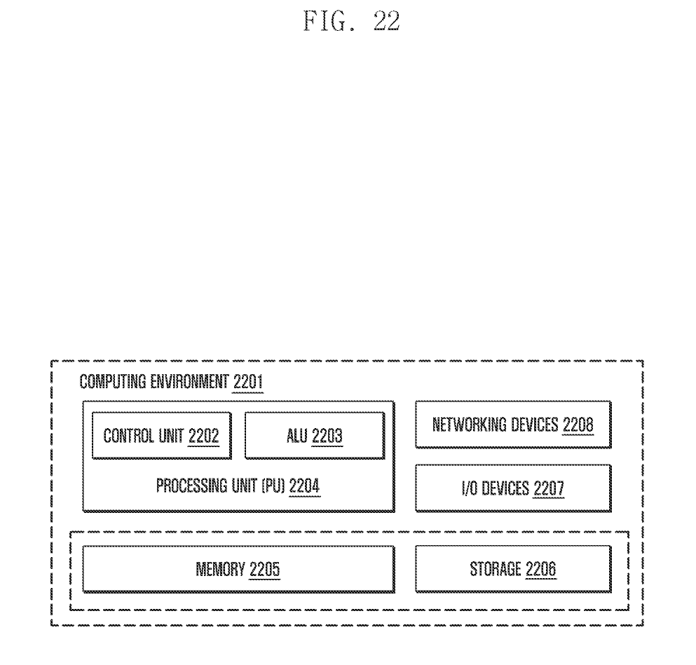

FIG. 22 illustrates a computing environment implementing the method and system for retrieving information from one or more information sources for determining the user's intent according to various embodiments of the present disclosure.

Referring to FIG. 22, the computing environment 2201 comprises at least one processing unit 2204 that is equipped with a control unit 2202 and an Arithmetic Logic Unit (ALU) 2203, a memory 2205, a storage 2206, plurality of networking devices 2208 and a plurality of Input output (I/O) devices 2207. The processing unit 2204 is responsible for processing the instructions of the algorithm. The processing unit 1604 receives commands from the control unit in order to perform its processing. Further, any logical and arithmetic operations involved in the execution of the instructions are computed with the help of the ALU 2203.

The overall computing environment 2201 can be composed of multiple homogeneous and/or heterogeneous cores, multiple Central Processing Units (CPUs) of different kinds, special media and other accelerators. The processing unit 2204 is responsible for processing the instructions of the algorithm. Further, the at least one processing unit 2204 may be located on a single chip or over multiple chips.

The algorithm comprising instructions and codes required for the implementation are stored in either the memory unit 2205 or the storage 2206 or both. At the time of execution, the instructions may be fetched from the corresponding memory 2205 and/or storage 2206, and executed by the processing unit 2204.

In case of any hardware implementations various networking devices 2208 or external I/O devices 2207 may be connected to the computing environment to support the implementation through the networking unit and the I/O device unit.

The various embodiments of the present disclosure can be implemented through at least one software program running on at least one hardware device and performing network management functions to control the elements. The elements shown in FIGS. 1, 2, 3, 9, 11A, 11B, 14A, 14B, 15, 19, and 22 include blocks which can be at least one of a hardware device, or a combination of hardware device and software module.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for retrieving information in a knowledge-based assistive network including a plurality of information sources, the method comprising:
receiving at least one localized query at each of the plurality of information sources, wherein the at least one localized query is sent in response to determining an intent associated with a user;
determining a semantic similarity between the intent and information of respective knowledge graphs each associated with one of the plurality of information sources, wherein the knowledge graphs each comprise information corresponding to the associated one of the plurality of information sources having knowledge about at least one subject; and
retrieving information from at least one information source in the knowledge-based assistive network in accordance with the determined semantic similarity.

2. The method of claim 1, further comprising generating one of the knowledge graphs at each of the plurality of information sources, wherein the generated knowledge graph is stored locally on each of the plurality of information sources.

3. The method of claim 1, wherein each of the knowledge graphs comprise the knowledge about the at least one subject clustered in at least one dynamic node, wherein the knowledge is dynamic information.

4. The method of claim 1, wherein the plurality of information sources comprises at least one of a friend electronic device, a friends-of-friend electronic device, a group electronic device, a department electronic device, a community electronic device, a company electronic device, an organization electronic device, a customer care electronic device, or an expert electronic device, wherein each of the plurality of information sources is associated with at least one person.

5. The method of claim 1, wherein the determining of the intent comprises:
extracting at least one item available in an object, wherein the object is displayed in an application; and
determining the intent of the user based on the at least one extracted item, wherein the intent indicates at least one of a topic, a subject, a knowledge, or an interest of the user.

6. The method of claim 5, wherein the item comprises at least one of a word vector or a token.

7. The method of claim 6, wherein the content of the word vector is distributed according to a probability distribution.

8. The method of claim 5, further comprising:
receiving the intent over the knowledge-based assistive network at a server;
interpreting a correlation between the at least one item of the intent; and
generating the localized query in accordance with the intent, wherein the localized query comprises the at least one item.

9. The method of claim 1, wherein the determining of the intent comprises:
receiving at least one search request from the user, wherein the search request is received from an application;
extracting at least one item from the at least one search request; and
determining the intent of the user based on the at least one extracted item, wherein the intent indicates at least one of a topic, a subject, knowledge, or an interest of the user.

10. The method of claim 1, wherein the determining of the semantic similarity between the intent and the information of the respective knowledge graphs each associated with one of the plurality of information sources comprises:
receiving the at least one localized query at each of the plurality of information sources in vicinity to the user;
deriving the at least one item from the localized query at each of the plurality of information sources;
deriving the information from the respective knowledge graphs at each of the plurality of information sources; and
determining the semantic similarity between the at least one item of the intent and the information from the respective knowledge graphs.

11. The method of claim 1, wherein the retrieving of the information from the at least one information source in the knowledge-based assistive network in accordance with the determined semantic similarity comprises:
for each of the respective knowledge graphs and the intent, determining whether the semantic similarity is greater than a similarity threshold; and
retrieving the information from at least one information source in the knowledge-based assistive network in response to determining that the semantic similarity is greater than the similarity threshold.

12. The method of claim 1, further comprising:
determining, at each of the of the plurality of information sources, a similarity of a user-information source pair based on the determined semantic similarity between the intent and respective knowledge graph; and
integrating the similarity of the user-information source pair to develop the knowledge-based assistive network.

13. The method of claim 1, further comprising dynamically recommending the information from the at least one information source to the user in at least one item in an object in accordance with the determined semantic similarity.

14. The method of claim 1, further comprising displaying the retrieved information from the at least one information source to the user in accordance with the determined semantic similarity,
wherein the displaying of the retrieved information from the at least one information source to the user in accordance with the determined semantic similarity comprises:
determining whether at least one person associated with the information from the at least one information source is willing to assist the user; and
dynamically displaying the information from the at least one information source to the user in accordance with the determined semantic similarity in response to determining that the at least one person associated with the information from the at least one information source is willing to assist the user.

15. The method of claim 1, further comprising:
determining a ranking for each of the at least one information source in accordance with the determined semantic similarity; and
sorting each of the at least one information source for display according to the ranking determined for each of the at least one information source.

16. The method of claim 1, further comprising facilitating a real-time communication session over the knowledge-based assistive network between the user and at least one person associated with the information from the at least one information source.

17. The method of claim 16, wherein the real-time communication session comprises an online chat session.

18. The method of claim 1, further comprising facilitating a non-real-time communication session over the knowledge-based assistive network between the user and at least one person associated with the information from the at least one information source.

19. The method of claim 18, wherein the non-real-time communication session comprises at least one of an offline chat session or an offline email session.

20. The method of claim 1, further comprising:
periodically monitoring at least one activity associated with the user; and
updating the respective knowledge graphs based on an output of the monitoring.
